(19) United States
(12) Patent Application Publication
(10) Pub. No.: US 2025/0162451 A1
(43) Pub. Date: May 22, 2025

(54) METHODS AND SYSTEMS FOR CHARGING ELECTRIC VEHICLES

(71) Applicant: Martin Tremblay, Montreal (CA)

(72) Inventor: Martin Tremblay, Montreal (CA)

(21) Appl. No.: 19/032,019

(22) Filed: Jan. 18, 2025

Related U.S. Application Data
(63) Continuation of application No. 15/820,415, filed on Nov. 21, 2017.
(60) Provisional application No. 61/908,124, filed on Nov. 24, 2013.

(51) Int. Cl. B60L 58/12; B60L 53/30; B60L 53/65; B60L 53/66; B60L 53/68; G06F 3/04842; G06Q 10/02; G06Q 50/12

(52) U.S. Cl. CPC B60L 58/12; B60L 53/305; B60L 53/65; B60L 53/665; B60L 53/68; G06F 3/04842; G06Q 10/02; G06Q 50/12; B60L 2240/70; B60L 2250/14; B60L 2260/52; B60L 2260/54; Y02T 10/70; Y02T 10/7072; Y02T 10/72; Y02T 90/12; Y02T 90/14; Y02T 90/16; Y02T 90/167; Y04S 30/14

(57) ABSTRACT

A charging service for electric vehicles is provided. The charging service may allow electric vehicles to be charged when certain conditions are met (e.g., at certain times, when certain battery charge levels are reached, when located at certain sites, etc.), without users of these electric vehicles having to charge the vehicles themselves. Other features pertaining to charging of electric vehicles are also provided, such as an application for estimating a driving range (e.g., distance and/or time) available with a current battery charge level of an electric vehicle.

### CROSS-REFERENCE TO RELATED APPLICATION

The present application claims the benefit under 35 U.S.C. § 120 of U.S. Provisional Patent Application Ser. No. 61/908,124, filed Nov. 24, 2013, hereby incorporated by reference herein.

### FIELD

The invention relates to charging of electric vehicles.

### BACKGROUND

Electric vehicles have existed for decades. However, despite being a more environment-friendly option than internal combustion vehicles, and although they have a lower cost of operation, the percentage of electric vehicles on the road still remains low in many regions.

One reason for this may be so-called “range anxiety”, or the fear of not being able to complete a trip or get to a charging station due to excessive depletion of battery charge.

It has indeed been reported that the fear of running out of battery power is one of the main reasons why drivers were found to be slow to adopt electric vehicles as a mainstream mode of private transport.

Moreover, some drivers are eager to purchase electric vehicles for cost and environmental reasons, yet if they tend to park outdoors both at home and at work, they may lack access to facilities that provide reliable and rapid battery charging.

Thus, technology that would expand the available options for charging an electric vehicle would be welcomed by manufacturers of electric vehicles as well as individuals with range anxiety and/or a concern for the environment.

### SUMMARY

According to an aspect of the invention, there is provided a charging service for electric vehicles. The charging service may be condition-based in some embodiments.

According to another aspect of the invention, there is provided a computer-implemented method for providing a charging service. The computer-implemented method comprises: determining, based on information regarding an electric vehicle that is stored in a database, that the electric vehicle is to be charged; and outputting a command to charge the electric vehicle.

According to another aspect of the invention, there is provided an apparatus for providing a charging service. The apparatus comprises: a processing portion for determining, based on information regarding an electric vehicle that is stored in a database, that the electric vehicle is to be charged; and an output for outputting a command to charge the electric vehicle.

According to another aspect of the invention, there is provided a computer-readable storage medium storing computer-readable instructions which, when executed by a computing apparatus, cause the computing apparatus to implement a method for providing a charging service that comprises: determining, based on information regarding an electric vehicle that is stored in a database, that the electric vehicle is to be charged; and outputting a command to charge the electric vehicle.

According to another aspect of the invention, there is provided a computer-implemented method for providing a charging service. The computer-implemented method comprises: determining, based on information regarding a plurality of electric vehicles, that a given electric vehicle of the electric vehicles is to be charged; and outputting a command to charge the given electric vehicle.

According to another aspect of the invention, there is provided an apparatus for providing a charging service. The apparatus comprises: a processing portion for determining, based on information regarding a plurality of electric vehicles, that a given electric vehicle of the electric vehicles is to be charged; and an output for outputting a command to charge the given electric vehicle.

According to another aspect of the invention, there is provided a computer-readable storage medium storing computer-readable instructions which, when executed by a computing apparatus, cause the computing apparatus to implement a method for providing a charging service that comprises: determining, based on information regarding a plurality of electric vehicles, that a given electric vehicle of the electric vehicles is to be charged; and outputting a command to charge the given electric vehicle.

According to another aspect of the invention, there is provided a computer-implemented method comprising: applying at least one charging rule to at least one parameter value in order to determine that at least one electric vehicle is to be charged; and outputting a command to charge the at least one electric vehicle.

According to another aspect of the invention, there is provided a computer-readable storage medium storing computer-readable instructions which, when executed by a computing apparatus, cause the computing apparatus to implement a method comprising: applying at least one charging rule to at least one parameter value in order to determine that at least one electric vehicle is to be charged; and outputting a command to charge the at least one electric vehicle.

According to another aspect of the invention, there is provided a charging service apparatus. The charging service apparatus comprises: a memory for storing at least one charging rule; an input for receiving at least one parameter value; a processor configured to apply the at least one charging rule to the at least one parameter value in order to determine that at least one electric vehicle is to be charged; and an output for outputting a command to charge the at least one electric vehicle.

According to another aspect of the invention, there is provided a charge port system for an electric vehicle. The charge port system comprises: a charge port capable of being locked and unlocked such that, when unlocked, the charge port allows an electrical source to wiredly connect to a battery of the electric vehicle; and a control system for controllably unlocking the charge port in response to a signal received from outside the electric vehicle.

According to another aspect of the invention, there is provided a charge port access control system for controlling access to a charge port of an electric vehicle from outside the electric vehicle. The charge port is capable of being locked and unlocked such that, when unlocked, the charge port allows an electrical source to wiredly connect to a battery of the electric vehicle. The charge port access control system comprises: an input for receiving an indication that the electric vehicle requires charging; and an output for sending a signal from outside the electric vehicle to unlock the charge port.

According to another aspect of the invention, there is provided an electric vehicle comprising: a chassis with wheels; a steering system; a battery; a drive train powered by the battery; a throttle for controlling an amount of power from the battery used to drive the drive train; a brake; a charge port capable of being locked and unlocked such that, when unlocked, the charge port allows an electrical source to wiredly connect to the battery; and a control system for controllably unlocking the charge port in response to a signal received from outside the electric vehicle.

According to another aspect of the invention, there is provided a computer-readable storage medium comprising computer-readable instructions which, when executed by a computing apparatus, cause the computing apparatus to execute a driving range estimation application for an electric vehicle. The driving range estimation application comprises: receiving information regarding at least one of traffic conditions, weather conditions, road characteristics, and a time; determining, based on the information, an estimated driving range available with a current battery charge level of the electric vehicle; and causing the estimated driving range to be output to a user.

According to another aspect of the invention, there is provided a method comprising: a user entering into a rental agreement with a rental car company for renting an electric vehicle, the rental agreement including an activatable clause whereby a hotel assumes at least partial responsibility for recharging the electric vehicle when surrendered to a parking facility associated with the hotel; the user checking in to the hotel, thereby to activate the clause; the user surrendering the electric vehicle to the parking facility associated with the hotel; the user retrieving the electric vehicle from the parking facility, the vehicle having been recharged in accordance with the clause of the rental agreement.

According to another aspect of the invention, there is provided a method comprising: a hotel entity entering into an agreement with a rental car entity wherein the hotel entity assumes at least partial responsibility for recharging an electric vehicle rented by the rental car entity when the electric vehicle is surrendered to a parking facility associated with the hotel entity; upon the user checking in to the hotel entity and the user surrendering the electric vehicle to the parking facility associated with the hotel entity, the hotel entity causing the electric vehicle to be charged and allowing the user to retrieve the charged electric vehicle from the parking facility.

According to another aspect of the invention, there is provided a computer-readable storage medium comprising computer-readable instructions which, when executed by a computing apparatus, cause the computing apparatus to execute an online booking process graphical user interface (GUI), the online booking process GUI comprising: a GUI object via which a user is able to input information regarding a hotel reservation; and a GUI object via which a user is able to input electric vehicle information regarding in association with the hotel reservation.

According to another aspect of the invention, there is provided a computer-readable storage medium comprising computer-readable instructions which, when executed by a computing apparatus, cause the computing apparatus to execute an online booking process graphical user interface (GUI), the online booking process GUI comprising: a GUI object via which a user is able to submit a request to view a set of automobiles available to be rented in accordance with reservation criteria; and a GUI object via which a user is able to input electrical vehicle information to restrict the set of automobiles based on said electrical vehicle information.

Additional aspects may involve a computer-implemented method, an apparatus, and/or a computer-readable storage media comprising computer-readable instructions executable by a computing apparatus to cause the computing apparatus to execute a process for: (1) determining, based on a condition related to charging of an electric vehicle, that the electric vehicle is to be charged; and (2) outputting a command to charge the electric vehicle. This may additionally involve receiving information defining the condition related to charging of the electric vehicle.

Additional aspects may involve a computer-implemented method, an apparatus, and/or a computer-readable storage media comprising computer-readable instructions executable by a computing apparatus to cause the computing apparatus to execute a process for: (1) receiving information regarding an electric vehicle to be charged; and (2) causing issuance of a wireless signal from outside the electric vehicle (e.g., via a network or a device proximate to the electric vehicle) to enable access to a charging system of the electric vehicle (e.g., unlock a charge port of the electric vehicle, activate a charging circuit of the electric vehicle, etc.) in order to charge the electric vehicle. This may additionally require that the device from which the wireless signal is issued not be a key for operating the electric vehicle.

Additional aspects may involve a computer-implemented method, an apparatus, and/or a computer-readable storage media comprising computer-readable instructions executable by a computing apparatus to cause the computing apparatus to execute a process for: (1) receiving information about an electric vehicle charged at a facility requiring payment for a service provided to a user of the electric vehicle other than charging of the electric vehicle; and (2) adjusting an amount billed to the user based on the charging of the electric vehicle. The facility could be a hotel, parking lot, stadium, etc.

Additional aspects may involve a computer-implemented method, an apparatus, and/or a computer-readable storage media comprising computer-readable instructions executable by a computing apparatus to cause the computing apparatus to execute a process for: (1) receiving information about an electric vehicle charged at a hotel; and (2) adjusting an amount billed for a stay at the hotel by a guest associated with the electric vehicle based on the charging of the electric vehicle.

Additional aspects may involve a computer-implemented method, an apparatus, and/or a computer-readable storage media comprising computer-readable instructions executable by a computing apparatus to cause the computing apparatus to execute a process for: (1) receiving information about a hotel reservation via a computer network; and (2) providing an option to specify that the hotel reservation is associated with an electric vehicle (e.g., a guest for the hotel reservation is or will be using the electric vehicle).

Additional aspects may involve a computer-implemented method, an apparatus, and/or a computer-readable storage media comprising computer-readable instructions executable by a computing apparatus to cause the computing apparatus to execute a process for: (1) receiving information about a rental of a vehicle via a computer network; and (2) receiving information indicative of a desire for the vehicle to be an electric vehicle.

Additional aspects may involve a computer-implemented method, an apparatus, and/or a computer-readable storage media comprising computer-readable instructions executable by a computing apparatus to cause the computing apparatus to execute a process for: (1) receiving information about a rental of a vehicle via a computer network; and (2) providing an option to request that the vehicle be an electric vehicle.

Additional aspects may involve a computer-implemented method, an apparatus, and/or a computer-readable storage media comprising computer-readable instructions executable by a computing apparatus to cause the computing apparatus to execute a process for: (1) receiving information about a rental of a vehicle via a computer network; and (2) providing an option to request that the vehicle not be an electric vehicle.

Additional aspects may involve a computer-implemented method, an apparatus, and/or a computer-readable storage media comprising computer-readable instructions executable by a computing apparatus to cause the computing apparatus to execute a process for: (1) determining, based on information regarding a rented electric vehicle, that the rented electric vehicle is to be charged; and (2) outputting a command for a valet of a vehicle rental company providing the rented electric vehicle to charge the rented electric vehicle. By “valet of a vehicle rental company” this is intended to mean an individual or company working for, working for a subcontractor of, or otherwise working on behalf of the vehicle rental company.

Additional aspects may involve a computer-implemented method, an apparatus, and/or a computer-readable storage media comprising computer-readable instructions executable by a computing apparatus to cause the computing apparatus to execute a process for: (1) receiving information about a rented electric vehicle at a hotel; and (2) determining that the hotel has a relationship with a vehicle rental company providing the rented electric vehicle such that the hotel is to take an action related to charging of the rented electric vehicle while at the hotel. By an “action” it is intended that this could include charging the electric vehicle and/or not billing a user of the electric vehicle for charging the electric vehicle.

Additional aspects may involve a computer-implemented method, an apparatus, and/or a computer-readable storage media comprising computer-readable instructions executable by a computing apparatus to cause the computing apparatus to execute a process for: (1) receiving information about a rented electric vehicle at a hotel; (2) determining that the hotel has a relationship with a vehicle rental company providing the rented electric vehicle such that the hotel is to cause the rented electric vehicle to be charged while at the hotel; and (3) outputting a command to charge the rented electric vehicle while at the hotel

For example, certain aspects or embodiments may be expressed in a computer-implemented method comprising: applying at least one charging rule to at least one parameter value in order to determine that at least one electric vehicle is to be charged; and outputting a command to charge the at least one electric vehicle.

In a specific non-limiting embodiment, the command is output towards a charging unit over a communications network.

In a specific non-limiting embodiment, the method may further include monitoring the at least one parameter value and storing the at least one parameter value in a memory.

In a specific non-limiting embodiment, monitoring the at least one parameter value may comprise monitoring at least one parameter value for each of a plurality of electric vehicles that includes the at least one electric vehicle.

In a specific non-limiting embodiment, the method may further include, for a given electric vehicle in the plurality of electric vehicles, monitoring the at least one parameter value for the given electric vehicle comprises receiving a signal indicative of at least one of the at least one parameter value for the given electric vehicle and storing the received at least one parameter value in a memory.

In a specific non-limiting embodiment, the signal may be received from the given electric vehicle.

In a specific non-limiting embodiment, the signal may be received from a user associated with the given electric vehicle.

In a specific non-limiting embodiment, the received at least one parameter value may comprise an indication of a charge level of a battery used by the given electric vehicle.

In a specific non-limiting embodiment, applying the set of at least one charging rule to the at least one parameter value may include comparing the charge level of the battery used by the given electric vehicle to a threshold and, in case the charge level is below the threshold, identifying that the given electric vehicle is one of the at least one electric vehicle requiring charging.

In a specific non-limiting embodiment, the received at least one parameter value may comprise an indication of a location of the given electric vehicle.

In a specific non-limiting embodiment, the received at least one parameter value may comprise an indication of an amount of time that the given electric vehicle is expected to remain at its current location.

In a specific non-limiting embodiment, the received at least one parameter value may comprise an indication a credit worthiness of a user associated with the given electric vehicle.

In a specific non-limiting embodiment, the at least one parameter value may comprise an indication of a time of day.

In a specific non-limiting embodiment, the method may be implemented at least in part by a charging service provider and wherein the at least one charging rule includes at least one rule defined by the charging service provider.

In a specific non-limiting embodiment, the at least one charging rule may include, for each given electric vehicle in a plurality of electric vehicles that includes the at least one electric vehicle, a charging rule defined by a user associated with the given electric vehicle.

In a specific non-limiting embodiment, the command may include information regarding the at least one electric vehicle.

In a specific non-limiting embodiment, for a given electric vehicle of the at least one electric vehicle, the information regarding the given electric vehicle may include identification information identifying the given electric vehicle.

In a specific non-limiting embodiment, identifying the given electric vehicle may include at least one of a make, a model, a color, and a license plate number of the given electric vehicle.

In a specific non-limiting embodiment, for a given electric vehicle of the at least one electric vehicle, the information regarding the given electric vehicle may include location information indicative of a location of the given electric vehicle.

In a specific non-limiting embodiment, the location of the given electric vehicle may be a last-known location of the given electric vehicle.

In a specific non-limiting embodiment, the location of the given electric vehicle may be a current location of the given electric vehicle.

In a specific non-limiting embodiment, the method may further include consulting a database to determine the location of the given electric vehicle.

In a specific non-limiting embodiment, for a given electric vehicle of the at least one electric vehicle, the information regarding the given electric vehicle may include an amount of charge to supply to the given electric vehicle.

In a specific non-limiting embodiment, the method may further include determining the amount of charge to supply to the given electric vehicle based on a current battery charge level of the given electric vehicle.

In a specific non-limiting embodiment, the at least one electric vehicle may include a plurality of electric vehicles, and wherein the command includes a charging schedule identifying the plurality of electric vehicles

In a specific non-limiting embodiment, the charging schedule may specify, for each given electric vehicle of the electric vehicles, a time window within which to charge the given electric vehicle.

In a specific non-limiting embodiment, the method may further include generating the charging schedule based on at least a current location of each of the electric vehicles.

In a specific non-limiting embodiment, for a given electric vehicle of the at least one electric vehicle, the method may comprise sending a confirmation request to a user associated with the given electric vehicle, and wherein a command to charge the given electric vehicle is not sent unless a message indicative of acceptance of the confirmation request is received.

In a specific non-limiting embodiment, sending the confirmation request to the user of the given electric vehicle may comprise consulting a database to determine contact information for the user of the given electric vehicle, and sending the confirmation request to an address or a phone number contained in the contact information.

In a specific non-limiting embodiment, sending the confirmation request may occur over a communications network.

In a specific non-limiting embodiment, the method may further include, for a given electric vehicle of the at least one electric vehicle, debiting a financial account of a user associated with the given electric vehicle.

In a specific non-limiting embodiment, the method may further include configuring an account for a user of a given electric vehicle of the at least one electric vehicle.

In a specific non-limiting embodiment, the method may further include interacting with the user over a communications network to enable the user to configure the account.

In a specific non-limiting embodiment, the command may be sent to an operator of a mobile charging unit.

In a specific non-limiting embodiment, the mobile charging unit may be portable.

In a specific non-limiting embodiment, sending the command may comprise contacting an operator of a mobile charging unit by telephone, text message or email.

In a specific non-limiting embodiment, sending the command may comprise updating a status on a social network site.

In a specific non-limiting embodiment, the at least one electric vehicle may include a plurality of electric vehicles, the method further comprising outputting a plurality of commands, each of the commands being a command to a respective subset of the plurality of electric vehicles.

In a specific non-limiting embodiment, each of the commands may be sent to a corresponding operator of at least one mobile charging unit.

In a specific non-limiting embodiment, each of the commands may be sent towards a corresponding one of a plurality of mobile charging units.

In a specific non-limiting embodiment, the method may further include associating different respective subsets of the plurality of electric vehicles with different mobile charging units based on relative locations among the mobile charging units and the electric vehicles.

In a specific non-limiting embodiment, the method may further include generating an urgency level for charging the at least one electric vehicle.

In a specific non-limiting embodiment, the method may further include generating a time limit within which the at least one electric vehicle is to be charged.

In various embodiments, charging an electric vehicle can be done by a mobile charging unit traveling or transported to the electric vehicle or by driving or otherwise transporting (e.g., with a tow truck) the electric vehicle to a stationary charging unit.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows an example of an electric vehicle charging architecture that can be used to provide a charging service for electric vehicles in accordance with an embodiment of the invention;

FIG. 2 shows an example of contents of a database of a charging service operations center;

FIG. 3 shows an example of processes executed by the charging service operations center;

FIG. 4 shows an example of a user of a communication device interacting with the charging service operations center;

FIG. 5 shows an example of an electric vehicle wirelessly transmitting information towards the charging service operations center;

FIG. 6 shows an example of a condition verification process executed by the charging service operations center;

FIG. 7 shows an example of a flowchart representing steps of the condition verification process executed by the charging service operations center;

FIGS. 8 and 9 show examples of a charging command being output by the charging service operations center;

FIG. 10 shows an example of information conveyed by a charging command output by the charging service operations center;

FIGS. 11 and 12 show further examples of a charging command being output by the charging service operations center;

FIGS. 13 and 14 show further examples of a charging command being output by the charging service operations center;

FIG. 15 shows an example of restricted access to a charge port of an electric vehicle to be charged;

FIG. 16 shows an example of a user's computing device running an application estimating a remaining driving range of an electric vehicle in accordance with another embodiment that may be used without needing to provide the charging service;

FIG. 17 shows an example of information regarding charging of an electric vehicle transmitted to the charging service operations center in accordance with another embodiment;

FIG. 18 shows an example of a computing apparatus which may be comprised by a component mentioned herein;

FIG. 19 shows an example of a booking system implementing an online booking process during which electric vehicle information may be specified;

FIG. 20 shows an example screen shot that may be presented by a hotel booking system during the online booking process;

FIGS. 21A to 21C show example screen shots that may be presented by a car rental booking system during the online booking process;

FIGS. 22A and 22B show examples of a booking system implementing a booking process for renting a car; and

FIGS. 22C shows an example of a booking system implementing a booking process for booking a hotel.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

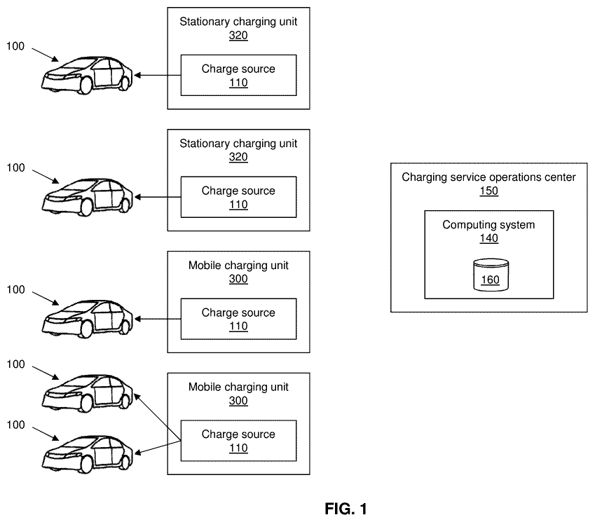

With reference to FIG. 1, there is shown an example of an electric vehicle charging architecture that can be used to provide a charging service for electric vehicles 100 in accordance with an embodiment of the invention. The electric vehicles 100 may be geographically distributed in an area such as a parking lot, a street, a neighbourhood, a city, a state or province, a country, or an even larger area.

As discussed further below, in some embodiments, the charging service allows respective ones of the electric vehicles 100 to be charged when certain conditions are met (e.g., at certain times, when certain battery charge levels are reached, when located at certain sites, etc.), without users of these electric vehicles having to charge the vehicles themselves. This may be useful, for example, to mitigate “range anxiety” issues that may affect some users and/or to facilitate charging in situations where reliable or rapid charging equipment may not be readily available to some users.

### A. General

The electric vehicles 100 use a battery to provide power to a drive train. For example, in some cases, the electric vehicles can be plug-in all-electric vehicles (such as the Nissan Leaf, the Ford Focus Electric, and the Tesla Model S) or plug-in hybrid electric vehicles (such as the Toyota Prius Hybrid, the Chevrolet Volt, and the Ford Fusion Energi). The user manuals of these vehicles are hereby incorporated by reference herein. Such electric vehicles may comprise a chassis with wheels, a steering system, a throttle to control an amount of power from the battery used to power the drive train, a brake, and various other components, as is well known. Of course, the electric vehicles being envisaged here are not limited to passenger cars, and could include vans, trucks and motorcycles, to name a few other possibilities.

Each of the electric vehicles 100 includes a battery that can hold up to a certain maximum charge or capacity. Driving an electric vehicle discharges its battery at a rate that depends on a variety of factors, including speed, external temperature, terrain, traffic, driving behaviour (e.g., braking, turning), aerodynamics of the vehicle, etc.

The battery of each of the electric vehicles 100 can be charged from any one of a plurality of charge sources 110 external to the electric vehicle. In some cases, a charge source may be an electrical outlet (e.g., wall outlet) connected to a power grid provided by an electric utility. In other cases, a charge source may be a generator powered by diesel, natural gas, etc. In further examples, a charge source may be an electrochemical or static storage device with a capacity that exceeds the capacity of the electric vehicle's battery. Such static or electrochemical storage devices may themselves be replenished with charge produced by a generator, solar panels, etc. Still other examples of a charge source exist, such as third-party electric vehicles with close to a full charge, and which could be partly discharged on an as-needed basis.

At least two main mechanisms exist for transferring charge from a given one of the charge sources 110 to the battery of a given one of the electric vehicles 100:
a) In a first example, referred to as “wired” charging, an electric cable directly connects the charge source (e.g., wall outlet, generator, high-capacity storage device) to a charge port of the electric vehicle. The electric cable carries a flow of current to the battery of the electric vehicle. A connector at the extremity of the electric cable may be plugged into the charge port of the electric vehicle. The connector at the extremity of the electric cable from the charge source may mate with a complementary connector of the electric vehicle's charge port. In this way, the electric vehicle's charge port may be configured with a design such that only a connector having a predetermined shape may be mated therewith. This can prevent inadvertent connections of the electric vehicle's battery to an unsuitable power source.

The current supplied to the battery during charging may be AC or DC, depending on the type of battery and the charging system used. Those skilled in the art will be familiar with the inverters, converters and other circuitry needed in order to implement a charging environment suitable for embodiments of the invention.
b) In a second example, referred to as “wireless” charging, a contact-less transfer is used. In one embodiment, contact-less transfer is inductive. Specifically, complementary inductive coils are provided on the charge source and on the electric vehicle. When current flows in the charge source's coil, a magnetic field is created and induces a flow of current in the electric vehicle's coil. This induced current is led to the battery in the electric vehicle, allowing charge to build up in the battery. In another embodiment, contact-less transfer is achieved using microwave energy. Specifically, a vehicle or building may be equipped with a charge source and a microwave emitter, while the electric vehicle is equipped with a microwave received and converter. The transmitter wirelessly transmits bursts of microwave energy to the receiver, which is converted into electrical energy at the electric vehicle and used to replenish the battery.

Other wired and/or wireless charge transfer mechanisms may exist, such as radio-frequency, electrostatic, piezoelectric, etc.

### B. Stationary Charging Unit

In some embodiments, each of at least some of the charge sources 110 may be stationary, i.e., configured to remain at a predetermined site (e.g., a particular facility) at which it is connected to a power grid. For instance, the charge source 110 may include an electric outlet connected to the power grid and part of a stationary charging unit 320. In some examples of implementation, the stationary charging unit 320 may be a charging station dedicated to charging electric vehicles (e.g., a charging station commercialized or operated by charging station providers such as ChargePoint, General Electric, etc.). In other examples of implementation, the stationary charging unit 320 may be a wall outlet. The predetermined site at which the stationary charging unit 320 remains may be any suitable facility or other location, such as a parking area of an office building, a hotel, an airport, an arena or stadium, a hospital, a shopping center, and/or another public or private place.

### C. Mobile Charging Unit

In some embodiments, each of at least some of the charge sources 110 is mobile. For example, the charge source may include a generator or high-capacity storage device mounted on or otherwise part of a mobile charging unit 300. For instance, the mobile charging unit 300 could be implemented by a tow truck or other service vehicle. For example, the mobile charging unit 300 could be based on the mobile EV charging service vehicle provided by AAA (formerly the American Automobile Association) such as described on webpages at http://www.az.aaa.com/automotive/evmobile and http://www.aaawa.com/about/newsroom/release.asp?ref=270, hereby incorporated by reference herein.

In some examples of implementation, the charge source 110 may even be portable, e.g., carried by a human and deposited in proximity to the electric vehicle that is to be charged. This may facilitate charging operations in areas such as busy streets, parking lots or garages.

In some embodiments, the mobile charging unit 300 may have the capability of charging more than one electric vehicle at a time. For example, the mobile charging unit 300 could be implemented by a lightweight, propane-driven generator, such as the EV Mobile Charger product from Agero Inc., One Cabot Road, Medford, Massachusetts. This product is described on webpages at http://www.agero.com/products-services/roadside-assistance/ev-mobile-charger, hereby incorporated by reference herein.

### D. Charging Service Operations Center (CSOC)

In order to benefit from the charging service of certain embodiments of the invention, users of the electric vehicles 100 may establish a relationship with an entity referred to as a “charging service provider”. Specifically, users may subscribe to the charging service by establishing contact with the charging service provider and setting up an account, as well as setting up various charging rules that may define conditions under which charging is to occur.

The charging service provider handles user subscriptions and coordinates charging of the electric vehicles 100. In various example embodiments, the charging service provider may be a car manufacturer, a roadside assistance provider, a vehicle rental company, a municipality, a utility, a company or other organization dedicated exclusively to charging electric vehicles, an organization managing a parking facility (e.g., of a hotel, airport, shopping center, etc.), etc. Thus, depending on the business model of the charging service provider, actual charging of the electric vehicles 100 may be performed by the charging service provider itself or this activity may be contracted or relegated to one or more third parties.

In an example embodiment, the charging service provider may operate a charging service operations center (CSOC) 150, which may form part of the electric vehicle charging architecture of FIG. 1. For example, the CSOC 150 could be implemented using a computing system 140 comprising at least one computer including one or more processors for reading computer-readable instructions from a memory and executing them. For instance, the computer-readable instructions can include object code resulting from a software build. Execution of this object code causes the at least one computer to implement a variety of processes having properties described herein below.

In some embodiments, the CSOC 150 could be implemented as a server that is accessible over the Internet. Such a server may be associated with one or more IP addresses that are reachable over the Internet. In order for the CSOC 150 to have Internet connectivity, the CSOC 150 may utilize a data connection established by an Internet service provider (ISP). This data connection used by the CSOC 150 may physically traverse wired and/or wireless links.

In some cases, the CSOC 150 could reside in an office, residence or institution. In other cases, the CSOC 150 may be partly implemented by computing equipment installed on a mobile charging unit 300 and/or a stationary charging unit 320. The CSOC 150 may also be distributed among a plurality of physical sites, which may include one or more mobile charging units 300, one or more stationary charging units 320, and/or one or more buildings or other fixed sites.

The CSOC 150 may have access to a vehicle account database 160. For example, the vehicle account database 160 may be implemented by one or more read-writable memories. The vehicle account database 160 may include information pertaining to one or more of the electric vehicles 100 that subscribe to the charging service (sometimes referred to as “subscribing electric vehicles”).

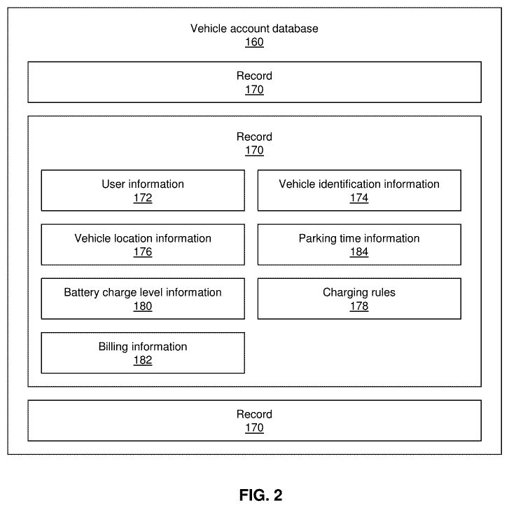

For the purposes of describing an example practical implementation, and with reference to FIG. 2, the information in the vehicle account database 160 may be organized in the form of records 170. Each record 170 includes account information identifying an electric vehicle and a user. In the specific example of implementation to be described below, there may be one record associated with each of the subscribing electric vehicles. However, such a data structure is not to be considered limiting, as there may be other possible arrangements, such as where one record is associated with each user, regardless of how many subscribing electrical vehicles may belong to that user.

The user identified in the record 170 for a particular electric vehicle may be a person (e.g., an individual or a company or other legal person) authorized to take decisions regarding charging of the particular electric vehicle and has established a relationship with the charging service provider (which, it will be recalled, is the entity that owns, operates or manages the CSOC 150). Typical examples of a user might include the vehicle's owner, lessee or renter. In such a setup, a single user could be associated with multiple vehicle records, as that user may own, lease or rent multiple electric vehicles.

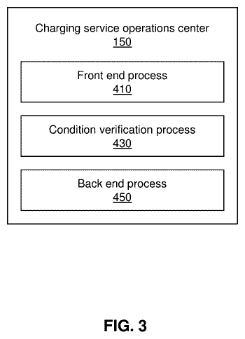

Considering now the record 170 for a particular electric vehicle, and with continued reference to FIG. 3, the account information in the record 170 could include, without limitation:
user information 172, which may include: identification information and credentials for a user (name, password, etc.), contact information (e.g., phone number, geographical address, email address, etc.) to reach the user, including in an emergency; etc.;
vehicle identification information 174, which may include: a make, model and color of the vehicle; registration information such as the vehicle identification number (VIN) and license plate of the particular electric vehicle, etc.;
vehicle location information 176, such as current, last-known and/or past locations of the particular electric vehicle;
parking time information 184 for when the particular electric vehicle is parked, such as an arrival time at the vehicle's parked location and/or an estimated departure time from the parked location;
charging rules 178;
battery charge level information 180, such as current and past charge levels of the particular electric vehicle's battery;
billing information 182 (credit card number, bank information, billing address, etc.);
etc.

In operation, with additional reference to FIG. 3, the CSOC 150 may execute one or more processes, which could include:
a front end process 410;
a condition verification process 430; and
a back end process 450.

### Front End Process

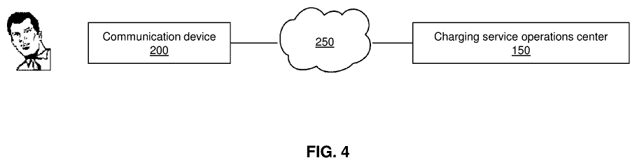

The front end process 410 refers to a process that interfaces with the user and allows the user to access the CSOC 150 and the vehicle account database 160 in order to provide and obtain information of various sorts. The user may interface with the front end process 410 in a variety of ways. For example, and with reference to FIG. 4, the user may employ a communication device 200 to communicate with the CSOC 150 over a communications network 250, which, for instance, may be implemented by a data network (e.g., the Internet), a public telephony network (e.g., the PSTN), and/or a cellular network.

For instance, in some embodiments, the communication device 200 may include a desktop or laptop computer, a tablet, a smartphone or another internet-enabled device to access the CSOC 150 over the Internet.

In one example, the user may use his or her internet-enabled device 200 to visit a website associated with the CSOC 150. The front end process 410, which may run on the server that implements the website, may interact with the user to solicit credentials such as a username and password, or a vehicle registration number and a password.

In another example in which the communication device 200 includes a smartphone or tablet, the user may download an application (app) from a repository (e.g., iTunes, Android Market, etc.) onto the smartphone or tablet. Upon activation of the app on the smartphone or tablet, the user may access certain features of the charging service locally on the smartphone or tablet. For example, the user may have access to maps and current location information, and may have the ability to enter certain information online. In addition, a data connection can be established (e.g., over the Internet) with the front end process 410 executed by the CSOC 150, which executes a complementary server-side application as part of the front end process 410.

In other embodiments, the communication device 200 may include a telephone that the user may employ to establish a conventional telephony link in order to communicate with a customer service representative of the charging service provider. The customer service representative may be tasked with entering the information into the CSOC 150, e.g., via a computer or other data entry tool.

Another way in which the user may interface with the front end process 410 is indirectly through a customer service system of a hotel, airport, shopping center, etc., or of any other facility at which the user may be a customer. For example, the user may physically interact with a person such as at a guest services desk or other customer service representative, and this person may collect the relevant information regarding the use of a communication device to communicate with the CSOC 150 over a communications network and/or enter the information directly into the CSOC 150 using a communication device (e.g., a computer terminal) available to that person. In another scenario, the user may interact with an automated booth (e.g., at a parking garage), where relevant information is entered either by the user or based on image recognition based on images captured by cameras.

By virtue of interfacing with the front end process 410, it will be appreciated that the user may be able to perform various actions such as setting up charging rules 178 for the electric vehicle(s) 100 that the user controls. In this regard, the front end process 410 may provide a fair amount of flexibility in allowing customization of the charging rules 178. Flexibility may be provided in terms of allowing the user to craft rules that reflect with a high degree of precision certain conditions under which the user wishes charging to take place. In an embodiment, these conditions may be validated and potentially overridden by an expert system forming part of the front end process 410. For example, if the user sets one of the charging rules as “charge when the vehicle's battery charge level has dropped below 99%”, this could be viewed as an invalid rule, as it would result in a charge having to be provided all the time regardless of the actual necessity of providing a charge, which could make it an unduly inefficient process for the charging service provider.

It is also envisaged that the user might not set up any charging rules 178 through the front end process 410. In this case, the charging rules 178 stored in the record 170 may consist of default charging rules. Such charging rules may be fixed for all vehicle makes and models, or they could be based on vehicle make and model as specified in the vehicle identification information 174.

Also, the user may carry out administrative tasks using the front end process 410, such as changing their password or contact information, associating themselves with a new vehicle, removing an existing vehicle from their account, setting up the terms of payment, etc. Also, the user may log in to the CSOC 150 to cancel any charging event that is scheduled to be fulfilled. This may prove useful in the case where the user needs to hastily change the location of his or her vehicle that had up until then been parked.

In view of the above, the types of information that the user may wish to convey to the CSOC 150 via the front end process 410 may include, without limitation, one or more of:
a make, model, color, and/or a license plate number of an electric vehicle of the user;
time-based charging rules, such as schedule-based charging rules (e.g., charge my vehicle every Monday and Thursday between 10am and 4pm) or other charging rules based on time (e.g., a particular day, a particular time of day, etc.);
battery-level-based charging rules (e.g., charge my vehicle when the vehicle's battery charge level has dropped below 50%, or is expected to drop below 30% in the next 24 hours);
event-based charging rules (e.g., charge my vehicle during a stay at a hotel);
hybrid charging rules (e.g., charge my vehicle every Monday, Wednesday and Friday but only if the battery charge level is at 50% or less);
billing information;
emergency contact information number;
command to cancel the next scheduled charging event;
etc.

Again, it is recalled that some of the above information may be entered by a third-party intermediary (such as, for example, a guest services representative at a hotel) or by an automated device (such as, for example, a parking lot ticket dispenser).

In addition, the user may convey the location of the electric vehicle 100 to the CSOC 150. For example, the user may send a text message to a number associated with the CSOC 150 when the vehicle has been parked. Alternatively, the app executing on the user's smartphone or tablet may be used for this purpose. The app could have the ability to communicate with the CSOC 150 over a data connection established by the smartphone or tablet. Moreover, the app could use a location sensor of the smartphone or tablet to determine its location. Upon activating a particular function of this app (e.g., touching a certain area of the screen, etc.), the user may be able to convey (or cause to be conveyed), to the CSOC 150, the current location of the user (actually, of the user's smartphone or tablet), and therefore of the electric vehicle.

Also, when the electric vehicle 100 is parked, the user may convey the estimated departure time from the parked location to the CSOC 150. For example, the user may send a text message to a number associated with the CSOC 150 indicating how long the user intends to be parked at that location, or equivalently an estimated departure time from the parked location. As another example, the CSOC 150 may, upon determining that the electric vehicle is parked (e.g., by observing that the vehicle's location has remained unchanged for a prolonged period of time such as 30 mins or more) and that a condition to charge the vehicle may soon be met (e.g., within 4 hours), send a message (e.g., a text message, an email or a voice message) to the user's smartphone or other communication device asking the user to confirm (e.g., by clicking on a reply button or hyperlink in the message or calling a phone number associated with the CSOC 150 in the message) whether the car will stay there for at least a predetermined period of time (e.g., 2 hours). Alternatively, the front end process 410 at the CSOC 150 may detect that the electric vehicle is parked and, based on past user behaviour patterns and locations, may estimate the amount of time that the electric vehicle is expected to remain parked at the current location.

### Condition Verification Process

The condition verification process 430 can be viewed as executing independently of the front end process 410. The condition verification process 430 will be described in some detail later on. For now, suffice it to say that the condition verification process 430 may execute in a loop, in order to periodically or continually identify which electric vehicles 100 are to be charged at which times, based on the account information for the various subscribing electric vehicles. When it is determined that one or more electric vehicles are to be charged at a particular time, which could be a present time or a future time, a “charging command” (i.e., a command to charge one or more electric vehicles) may be output. The charging command may identify the vehicle(s) to be charged. Optionally, the charging command may also identify a time at which charging is to occur and/or an amount of charge to be supplied, to allow optimized management of charge resources. In the case where multiple vehicles are to be charged in a relatively short period of time, the condition verification process 430 may also determine the order in which vehicles should be charged, based on a variety of considerations and factors, such as for example the vehicles' individual locations and past parking patterns.

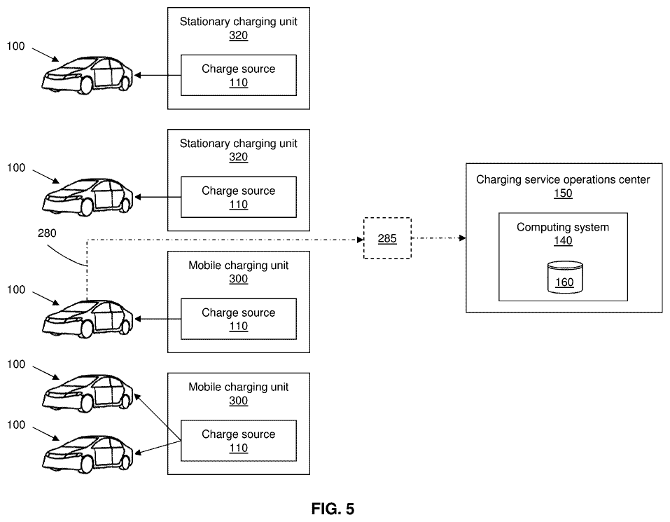

With additional reference to FIG. 5, certain types of information utilized by the condition verification process 430 may be gathered by the electric vehicle 100 and communicated over a wireless communication link 280.

The wireless communication link 280 may be established by virtue of a wireless transponder in the electric vehicle 100, such as, for instance, that provided by the OnStar™ system provided by General Motors Company of Detroit, Michigan. The OnStar™ system is described on webpages at https://secure.myvolt.com/web/portal/home and https://www.onstar.com/web/portal/home?g=1, hereby incorporated by reference herein. The wireless communication link 280 may utilize radio-frequency, microwave or ultrasonic frequencies, for example. In other cases, the wireless communication link 280 may employ the bidirectional communications functionality of a GPS unit in the electric vehicle 100 (e.g., a built-in GPS module or a GPS device brought inside the vehicle). The wireless communication link 280 may support connection-based (e.g., using TCP/IP) or connection-less (e.g., SMS or UDP) communications protocols. Communication over the wireless communication link 280 may be in analog or digital form, and may be encrypted.

In one embodiment, the wireless communication link 280 may directly connect transceiver circuitry of the electric vehicle 100 to the CSOC 150, such as where a telephony link is established between these two entities. In other embodiments, the wireless communications link 280 need not be directly established between the vehicle 100 and the CSOC 150. Instead, the wireless communication link 280 may be established between the electric vehicle 100 and an intermediate entity 285 (e.g., on the Internet). This can be achieved via a base station and other components of a wireless communications infrastructure. The base station may be operated by a telecommunications service provider (telco). The base station may then be connected to a gateway, which provides a link over the Internet or another network to the intermediate entity 285 (e.g., a website). The gathered information may then be transmitted (or redirected) from the intermediate entity 285 to the CSOC 150 using Internet or non-Internet means.

The types of information that the electric vehicle 100 may wirelessly send towards the CSOC 150 may include, without limitation:
battery charge level information, such as a current battery charge level (or a series of battery charge levels for various times in the past). The battery charge level information may be obtained using techniques such as those that are available with the Chevrolet Volt and the Nissan Leaf, such as described on webpages at https://secure.myvolt.com/web/portal/home and http://www.nissanusa.com/innovations/carwings.article.html, hereby incorporated by reference herein.
vehicle location information, such as a current vehicle location (or a series of vehicle locations for various times in the past). The current vehicle location may be obtained by an on-board GPS and then supplied to the CSOC 150. In an alternative embodiment, the vehicle 100 may emit a beacon which is decoded and tracked (e.g., triangulated) by the CSOC 150 or the intermediate entity 285 in order to derive the vehicle's location.

It should be appreciated that the above information may be communicated spontaneously by the electric vehicle 100, either periodically or asynchronously. Alternatively, the CSOC 150 may send a request to receive the information from the electric vehicle 100.

It should also be appreciated that the aforementioned information may be stored in an electronic control unit (ECU) of the electric vehicle 100. The ECU may thus be equipped with a wireless transponder for relaying the above information over the wireless communication link 280. Alternatively, the wireless transponder may be separate from the ECU and may extract the relevant data from the ECU using any one of a variety of available technologies, including on-board diagnostic connectors and protocols, such as OBD II.

### Back End Process

The back end process 450 may take care of invoicing or debiting the user. The back end process 450 may be invoked or activated each time the charging command has been output, or on a periodic (e.g., weekly or monthly) basis. The amount billed or debited to the user may vary depending on a variety of factors, which may include:
the amount of charge that was supplied;
the distance that has to be covered by the mobile charging unit 300;
the time of day;
the urgency with which the charge has to be dispensed;
the number of charging events;
etc.

Independently of the above factors and the resulting usage fee, users may be charged a monthly or annual service or membership fee for access to the charging service.

In some embodiments, a pre-paid scenario is envisaged, such that the user would start off with a certain amount of credit, and this credit would be debited based on the frequency/amount of charging. For example, a certain pre-paid charging credit could be obtained at the time of purchasing or renting the electric vehicle.

Also as part of the back end process 450, the CSOC 150 may send a message (e.g., email, SMS, voice mail) in order to advise the user of the status of a charging event that has been initiated. For instance, messages may be generated once it has been decided to charge an electric vehicle, once charging of the vehicle has begun, once charging has been completed, and/or once the fee has been debited from the account.

In some embodiments, the charging service may be provided to the user as part of the purchase, lease or rent of the electric vehicle 100. For example, in some cases, when initially purchasing, leasing or renting the electric vehicle 100, the user may be subscribed to the charging service by default or as an option. The charging service may be provided at no additional charge or for a fee included in the purchase, lease or rent price (e.g., for a predetermined number of charging events per month or year and/or for a predetermined number of months or years, etc.). In cases where a fee is paid, the fee may be established based on a number of charging events expected to occur.

### E. Condition Verification Process Details

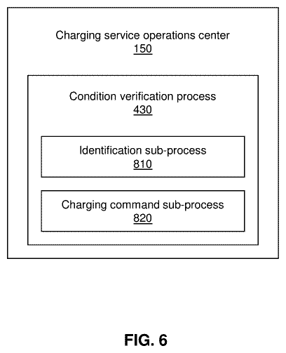

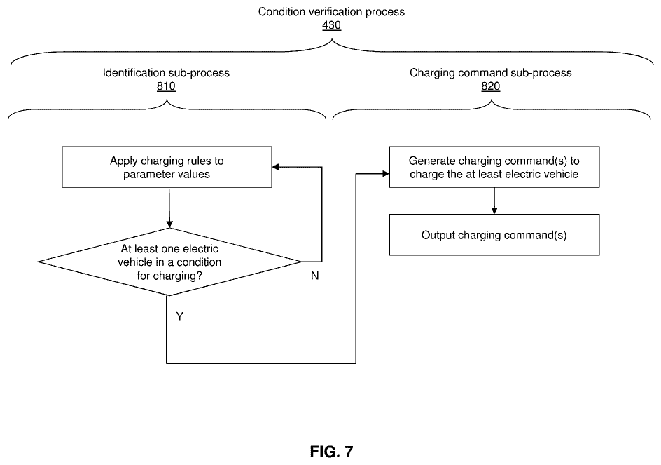

With additional reference to FIGS. 6 and 7, an example embodiment of the condition verification process 430 may include two main sub-processes, namely an identification sub-process 810 and a charging command sub-process 820. These two sub-processes may be implemented as separate processes, or they may be part of the same process.

In this embodiment, the main purpose of the identification sub-process 810 is to apply a set of charging rules to current parameter values in order to determine whether one or more electric vehicles is to be charged. In some implementations, this could involve determining whether one or more vehicles are in a condition for charging. Optionally, in the case where a particular electric vehicle is found to be in a condition for charging, the identification sub-process 810 may produce information relating to an urgency with which, and/or a time interval during which, charging of the particular electric vehicle is to occur.

For a particular electric vehicle 100, the charging rules can include the charging rules 178 stored in the account information for the particular electric vehicle. These charging rules 178 may be of varying types, including:
time-based charging rules, such as schedule-based charging rules (e.g., charge every Monday and Thursday between 10am and 4pm) or other charging rules based on time (e.g., a particular day, a particular time of day, etc.);
battery-level-based charging rules (e.g., charge when the vehicle's battery charge level has dropped below 50%, or is expected to drop below 30% in the next 24 hours);
location-based charging rules (e.g., charge when the vehicle is parked on level P3 of a parking garage);
event-based charging rules (e.g., charge my vehicle during a stay at a hotel);
hybrid charging rules including one or more of the above (or other) types of charging rules (e.g., charge every Monday, Wednesday and Friday but only if the battery charge level is at 50% or less);
etc.

Examples of parameter values to which the charging rules are applied may include:
an indication of a battery charge level of an electric vehicle;
an indication of a location of an electric vehicle;
an indication of an amount of time that an electric vehicle is expected to remain at its current location;
an indication of a time of day;
an indication of vehicle type;
an indication of battery type/capacity;
an indication of whether the electric vehicle is rented or owned by the user;
etc.

One or more of the current parameter values to which the charging rules are applied may be stored as account information for the particular electric vehicle 100. This could be the case for the battery charge level, for example. Other current parameter values to which the charging rules are applied might be stored elsewhere by the CSOC 150. These could include the current time of day, for example, which is not only constantly changing but also could be employed by the charging rules for numerous subscribing electric vehicles and therefore it might be more efficient to render this parameter value available in a shared manner rather than stored in the account information for each electric vehicle.

Charging rules that are specified by the user through interaction with the front end process 410 can be referred to as “user-defined charging rules”. In addition, one or more of the charging rules could be set by the charging service provider, referred to as “charging-service-provider-defined charging rules”. As an example of a charging-service-provider-defined charging rule, there may be certain streets or parking venues that are not sufficiently accessible with a mobile charging unit 300. In another example, the charging service provider may have a policy of not charging an electric vehicle unless the user's financial account is in good standing. To this end, another example of a parameter value to which the charging rules are applied may include an indication of the user's credit worthiness.

In still another embodiment, the charging rules may be default charging rules, which would mean that all of the charging rules are charging-service-provider-defined charging rules.

Still other charging rules that could be defined by the charging service provider are not specific to the electric vehicle 100, but are more general in nature. For example, if the charging service provider knows of a power outage that has occurred in certain parts of the city, or knows of an expected (e.g., rotating) power blackout, or has knowledge of a traffic jam in a specific location, actions could be taken to charge (or refrain from charging) certain electric vehicles in certain areas and at certain times, for a variety of reasons (e.g., in order to optimize resources or management of the electric power grid, etc.). Thus, other examples of parameter values to which the charging rules are applied may include an indication of a power outage (e.g., past, current or expected) or an indication of traffic conditions (e.g., current or expected).

The charging rules that are defined by the charging service provider may, but need not, be stored as account information in the user's record 170, or they may be stored elsewhere by the CSOC 150 and re-applied for multiple electric vehicles.

Another type of charging rule that could be applied by the condition verification process 430 may be predictive in nature. For example, consider the example charging rule whereby the electric vehicle 100 is to be charged if the battery level is expected to fall below a specified threshold within a specified period of time (e.g., number of hours or minutes). The specified threshold and the specified period of time may be specified by the user or by the charging service provider. In order to compute the expectation that the condition expressed in the rule will be met, the condition verification process 430 may need to access not only the current parameter values, but also past parameter values (historical usage data) and to run a predictive model.

For example, assume that the charging rule is “charge my vehicle before 4PM if the battery level is expected to fall below 50% in the next 24 hours”. In other words, the specified threshold is 50% and the specified number of hours is 24. (It is noted that either threshold—or both—could be user-defined or defined by the charging service provider.) Now, assume that past data shows that the user utilizes, on average, 20% of the battery charge on weekdays and 30% on weekend days. Consider now the case where the charging rule is applied to the current parameter value of the battery charge level, which is at 85%. Clearly, based purely on past usage, it is unlikely that the condition expressed by the charging rule will be met, because if it is a weekday, the charge will be expected to drop to around 65%, while if it were a weekend day, the charge would be expected to drop to around 55%. In either case, the remaining charge is expected to be higher than 50%, again based on historical data. Thus, charging of the electric vehicle would not occur on this particular day, although it would likely occur the next day, when the current charge level would be either 65% (weekday) or 55% (weekend day), at which point application of the charging rule would give a different outcome.

Of course, more complex charging rules and predictive models can be applied.

It is expected that if two or more charging rules are applied to the current parameter values for a particular electric vehicle 100, and only one of the charging rules leads to the conclusion that the particular electric vehicle should be charged, then the electric vehicle should indeed be charged. It is only when none of the charging rules leads to a positive determination that the particular electric vehicle should indeed not be charged. It is, of course, possible to include negative-dominant charging rules (i.e., “do NOT charge my vehicle when xxx condition occurs”). However, this would be done at the user's risk. For example, the user may not wish to have their electric vehicle charged on Thursdays, and the user should be aware that there may be a charging rule that would otherwise have led to the user's electric vehicle having been charged, which is overridden by that user's desire not to have their vehicle charged on Thursdays. Other reasons for not wanting to charge an electric vehicle could be based on power grid considerations, for example.

When the identification sub-process 810 determines that a given electric vehicle 100 is to be charged, the identification sub-process 810 alerts the charging command sub-process 820 of the identities of such vehicles. This can be done through any suitable protocol, including modification of global variables. The information transferred to the charging command sub-process 820 may include information such as one or more of: the location of the electric vehicle 100, the vehicle's make, model, color and/or license plate, and the amount of charge to supply. It may also include digital information (such as a code) that may permit access to the electric vehicle 100. The information transferred to the charging command sub-process 820 may additionally include contact information (e.g., a phone number or email address) where the user of the electric vehicle may be reached in case of emergency, for example. This information may be obtained from the appropriate record 170 stored in the vehicle account database 160.

Information generated by the identification sub-process 810 and transferred to the command sub-process 820 may also information relating to an urgency with which, and/or a time interval during which, charging of the particular electric vehicle is to occur. This could be expressed in the form of an urgency level or a number of minutes or hours, or a sliding scale wherein the urgency level increases with time. In order to compute this urgency level or time interval for a particular electric vehicle in a condition for charging, the identification sub-process 810 may consider the remaining charge level of the particular electric vehicle.

In a variant, before alerting the charging command sub-process 820, the identification sub-process 810 may seek confirmation from the users of individual electric vehicles 100 that have been identified as requiring a charge. For example, before committing to charging an electric vehicle that has been identified as requiring a charge, a text or email message could be sent to the user. The text or email message may ask the user to confirm that the vehicle will remain parked for a specific time interval in order to perform the charge (e.g., the next, say, 4 hours) or may request the user to input the number of hours for which the user is taking responsibility. That is to say, if the user confirms, but then moves the vehicle ahead of time, the user may be billed if an attempt has been made to locate or charge the vehicle during that time period. Confirmation from a user may be obtained in various other ways in other embodiments (e.g., by calling the user's phone).

The condition verification process 430 may keep executing the identification sub-process 810 regardless of the outcome of the set of charging rules.

In addition to with the identification sub-process 810, the condition verification process 430 runs the charging command sub-process 820. The main purpose of the charging command sub-process 820 is to output charging commands to trigger charging of the electric vehicles 100 that were identified by the identification sub-process 810.

The functionality of the charging command sub-process 820 may be implemented in various ways.

### Example of Implementation #1 of the Charging Command Sub-Process 820: Charging Service Provider Responsible for Actual Charging of Vehicles

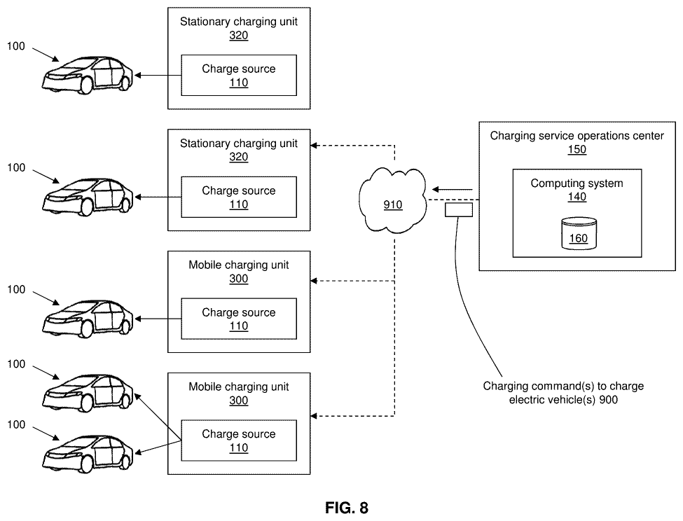

In this embodiment, and with reference to FIG. 8, the charging service provider operates not only the CSOC 150, but also one or more stationary charging units 320 and/or one or more mobile charging units 300. Accordingly, the charging command sub-process 820 may produce a charging command 900 that is released to one or more stationary charging units 320 and/or one or more mobile charging units 300.

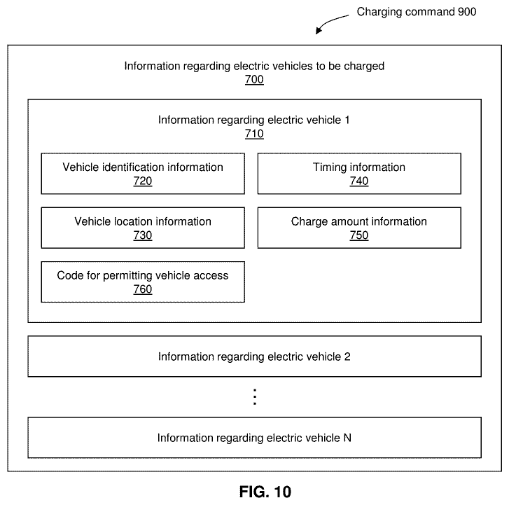

With additional reference to FIG. 10, there is shown an example of information that may be conveyed by the charging command 900 being released to a particular stationary charging unit 320 or mobile charging unit 300. The charging command 900 may comprise information 700 regarding one or more electric vehicles 100 to be charged by that stationary charging unit 320 or mobile charging unit 300. For instance, information 710 regarding a given electric vehicle 100 to be charged by the stationary charging unit 320 or mobile charging unit 300 may include vehicle identification information 720 identifying the given electric vehicle, such as its license plate and/or its make/model/color, and/or vehicle location information 730 indicative of a location of the given electric vehicle (i.e., a last-known location, a current location or an expected future location when charging is to occur). Some or all of the vehicle identification information 720 and/or of the vehicle location information 730 may be obtained from the appropriate record 170 stored in the vehicle account database 160.

In this embodiment, the information 710 regarding a given electric vehicle 100 to be charged may also include timing information 740 indicating when the given electric vehicle is to be charged by the stationary charging unit 320 or mobile charging unit 300 (e.g., an absolute time at which the given electric vehicle is to be charged or a position in a chronological order in which the given electric vehicle is to be charged, such as before or after, another electric vehicle is to be charged). For example, in cases where multiple electric vehicles 100 are to be charged by the stationary charging unit 320 or mobile charging unit 300, the charging command 900 may take the form of a charging schedule in which the electric vehicles 100 to be charged are presented in chronological order, together with a charge time window for each electric vehicle to be charged. In other embodiments, the charging command 900 produced for the stationary charging unit 320 or mobile charging unit 300 might not include scheduling or other timing information for the electric vehicle(s) 100 to be charged by the stationary charging unit 320 or mobile charging unit 300 (e.g., in which case it may be interpreted as meaning that each electric vehicle is to be charged as soon as possible).

In this embodiment, the information 710 regarding a given electric vehicle 100 to be charged may also include a code for permitting vehicle access 760.

The charging command sub-process 820 may consider a variety of factors when associating electric vehicles 100 with a charging time. Examples of factors that may be taken into consideration include:
the locations of the electric vehicles needing to be charged;
the estimated time remaining before the electric vehicles are to leave their current locations;
the current battery charge level of each electric vehicle;
traffic and weather information;
information regarding the fleet of mobile charging units 300, including the number of mobile charging units, their locations, the amount of charge that they can supply before they themselves need to be replenished, driver shift times, etc.

For example, consider the case where three electric vehicles 100 require charging, and two of them are proximate one another but are distant from the third. In such a case, it may more efficient, from a cost and time perspective, to charge the two nearby vehicles in sequence (or simultaneously). Now, whether they should be charged before the third remote vehicle, or whether the third, remote vehicle should be charge first could dependent on other factors, such as the location of the stationary charging unit 320 or mobile charging unit 300 relative to the various electric vehicles. Another factor could be the known usage patterns of the electric vehicles 100, namely if the two proximate vehicles have just been parked by individuals who typically leave them parked for 8 hours a day, and if the remote vehicle was parked 6 hours ago, it may be preferable to charge the remote vehicle before the two proximate ones, even if the stationary charging unit 320 or mobile charging unit 300 may be somewhat further away from the remote vehicle than the two proximate vehicles.

In some embodiments, the information 710 regarding a given electric vehicle 100 to be charged by the stationary charging unit 320 or mobile charging unit 300 may also include charge amount information 750 indicating the amount of charge to supply to the given electric vehicle.

In addition, in some embodiments, the information 710 regarding a given electric vehicle 100 to be charged may also include contact information (e.g., a phone number or email address) where the user of the given electric vehicle 100 may be reached in case of emergency, for example. This information may be obtained from the appropriate record 170 stored in the vehicle account database 160.

Once the charging command 900 has been generated for a particular stationary charging unit 320 or mobile charging unit 300, it can be output to be communicated to an operator of the particular stationary charging unit 320 or mobile charging unit 300 over a communications network 910. In order to communicate the charging command 900 from the CSOC 150 to the operator of a particular stationary charging unit 320 or mobile charging unit 300 over the communications network 910, a variety of approaches could be used.

For example, in some embodiments, the CSOC 150 could direct an SMS or email message conveying the charging command 900 to a phone number or email address associated with the operator. In other cases, the operator may have a social networking account such that the charging command 900 can be delivered via a user update effected by the underlying transmission mechanism of the social network (e.g., Facebook or Twitter, to name a few possibilities). In yet other cases, a phone call may be placed by the CSOC 150 to a phone number associated with a telephone of the operator of the stationary charging unit 320 or mobile charging unit 300 and leave an automated vocal message (e.g., a type of “robocall”) conveying the information about the one or more electric vehicles 100 to be charged according to the charging command 900. Thus, the communications network 910 may be implemented by the Internet, the PSTN, and/or a cellular network, to name a few examples.

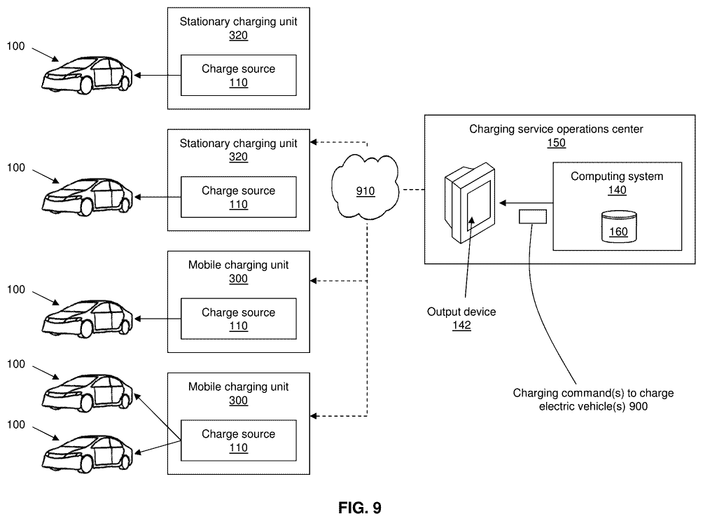

Alternatively, in some embodiments, with reference to FIG. 9, the charging command 900 may be output to a display, printer or other output device 142 (e.g., of a console, workstation, or other equipment) of the CSOC 150, where it could be perceived by a customer service representative in the form of a visual message. The customer service representative may then manually respond by contacting (e.g., by phone, SMS, or email) the operator of the stationary charging unit 320 or mobile charging unit 300 directly with the information about the one or more electric vehicles 100 to be charged according to the charging command 900 whose contents had been displayed, printed or otherwise output on the display, printer or other output device 142, such as the location, license plate, make, model, color, etc. of each electric vehicle to be charged.

Upon receiving and interpreting the charging command 900, or upon having been contacted by the customer service representative, the operator of the stationary charging unit 320 or mobile charging unit 300 can take actions to charge the identified electric vehicle(s) 100.

### Example of Implementation #2 of the Charging Command Sub-Process 820: Charging Service Provider Outsources Actual Charging of Vehicles

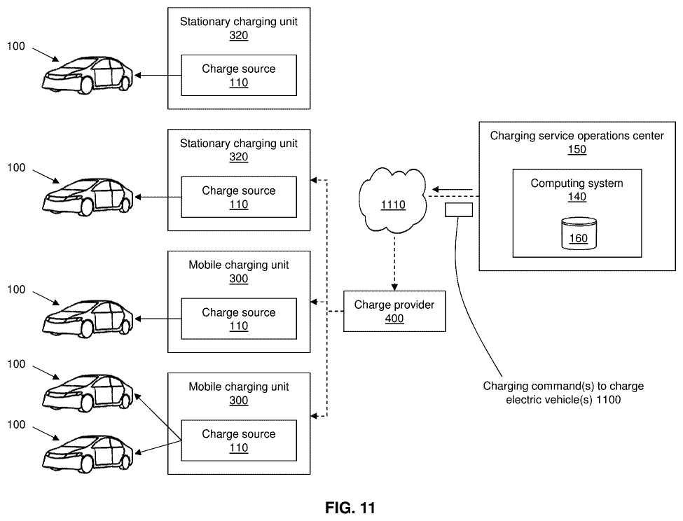

In this embodiment, with reference to FIG. 11, the charging service provider is not responsible for actual charging of the electric vehicles 100. Instead, the charging service provider has a business relationship with a charge provider 400, which takes care of the physical charging operations. For example, the charge provider 400 may be an operator of one or more charging stations implementing one or more stationary charging units 320 in a particular site or region and/or of one or more tow trucks or other service vehicles implementing one or more mobile charging units 300 in a particular region.

For instance, this scenario could be suited to the case where the charging service provider is a vehicle manufacturer that implements the CSOC 150 and subcontracts charging duties to the charge provider 400. This scenario could also be suited to the case where the charging service provider is a roadside assistance provider (e.g., AAA) that implements the CSOC 150 and subcontracts charging duties to the charge provider 400. Although a single charge provider 400 is described, it should be appreciated that there may be plural charge providers in a business relationship with the charging service provider.

In this embodiment, the charging command sub-process 820 may, in a manner similar to that which has already been stated, produce a charging command 1100, which may comprise information 700 regarding one or more electric vehicles 100 to be charged by the service provider 400, similar to that discussed above in connection with FIG. 10.

The difference here is that the charging command 1100 is communicated to the charge provider 400, and the charge provider 400 is responsible for getting the electric vehicles 100 to be charged to the one or more stationary charging units 320 and/or dispatching or otherwise moving the one or more mobile charging units 300 that it can in order to fulfill the requirements specified by the charging command 1100. For example, the charge provider 400 may have a customer-supplier relationship with the charging service provider, such that the charging service provider remunerates the charge provider 400 for executing the charging command.

The charging command 1100 can be output to be communicated to the operator of a particular stationary charging unit 320 or mobile charging unit 300 over a communications network 1110. In order to communicate the charging command 1100 from the CSOC 150 to the charge provider 400, a variety of approaches could be used.

For example, in some embodiments, an SMS or email message conveying the charging command 1100 could be sent from the CSOC 150 to a phone number or email address associated with the charge provider 400. In other cases, the charge provider 400 may have a social networking account such that the charging command can be delivered via a user update effected by the underlying transmission mechanism of the social network (e.g., Facebook or Twitter, to name a few possibilities). In yet other cases, a phone call may be placed by the CSOC 150 to a phone number associated with a telephone of the charge provider 400 and leave an automated vocal message (e.g., a type of “robocall”) conveying the information about the one or more electric vehicles 100 to be charged according to the charging command 1100. The communications network 1110 may be implemented by the Internet, the PSTN, and/or a cellular network, to name a few examples.

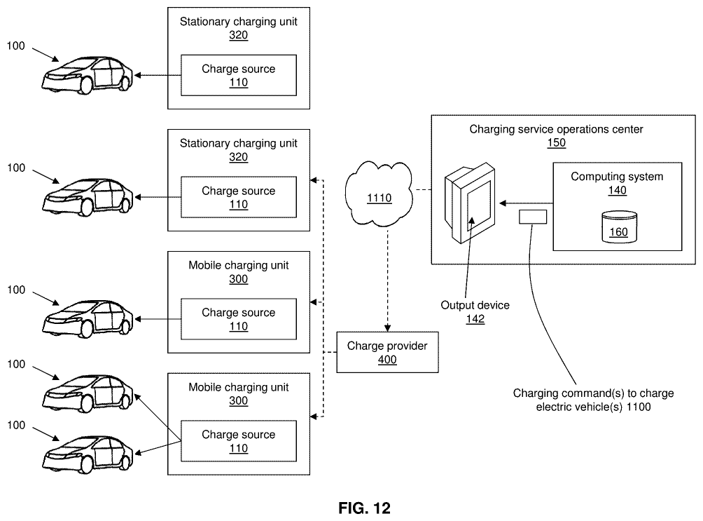

Alternatively, in some embodiments, with reference to FIG. 12, the information contained in the charging command 1100 could be output to a display, printer or other output device 142 (e.g., of a console, workstation, or other equipment) of the CSOC 150, where it can be perceived as a visual message by a customer service representative. The customer service representative may then respond by contacting the charge provider 400 (e.g., by phone, SMS or email) directly with the information about the one or more electric vehicles 100 to be charged according to the charging command 1100 whose contents had been displayed, printed or otherwise output on the display, printer or other output device 142, such as the location, license plate, make, model, color, etc. of each electric vehicle to be charged.

Upon receiving and interpreting the charging command 1100, or upon having been contacted by the customer service representative, the charge provider 400 can take actions to charge the one or more electric vehicles 100 using its one or more stationary charging units 320 and/or its one or more mobile charging units 300.

It should be appreciated that, in some alternative embodiments, the charging command may include simply the identity of each electric vehicle 100 to be charged and then it is up to the charge provider 400 to determine the location of the electric vehicle 100 based on obtained data. In that case, the charge provider 400 could be given access to GPS data for the identified electric vehicles in order to locate them, or may contact the user of the electric vehicle to request location information.

As part of the charging command sub-process 820 in this embodiment, the CSOC 150 may consider a variety of factors when associating electric vehicles with a charging time. Examples of factors that may be taken into consideration include:
the locations of the electric vehicles needing to be charged;
the estimated time remaining before the electric vehicles are to leave their current locations;
the current battery charge level of each electric vehicle;

In this embodiment, and in contrast with the example of implementation #1 discussed above, the charging service provider does not need to concern itself with information regarding the weather, traffic or the stationary charging units 320 and/or the mobile charging units 300, as this information is used by the charge provider 400 when determining the best way to use its stationary charging unit(s) 320 and/or dispatch or otherwise move its mobile charging unit(s) 300.

### Example of Implementation #3 of the Charging Command Sub-Process 820: Charging at Predetermined Facilities at Which Electric Vehicles are Brought

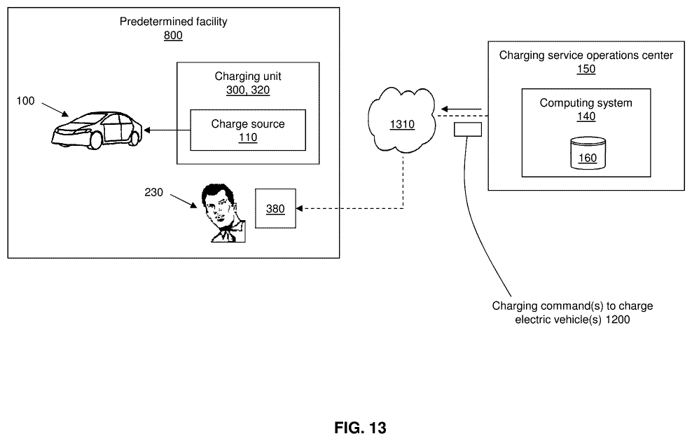

In some embodiments, with reference to FIG. 13, the charging service provider may arrange for an electric vehicle 100 to be charged at a predetermined facility 800 at which the electric vehicle 100 is brought, by a charge source 110 at that predetermined facility 800. In various examples, the predetermined facility 800 may be an office building, a hotel, an airport, an arena or stadium, a hospital, a shopping center, a parking lot, or any other suitable public or private place at which electric vehicles can be brought to be charged. The electric vehicle 100 can be charged by an employee 230 who is tasked with charging of electric vehicles using the charge source 110 at the predetermined facility 800. This employee 230, who will be referred to as a “valet”, picks up the electric vehicle 100 at the predetermined facility 800 (when the vehicle was brought there by the vehicle's user himself/herself or by another valet 230) or at a location remote from the predetermined facility 800 (at which the vehicle's user or another valet 230 parked the vehicle) and charges the electric vehicle 100 using the charge source 110 at the predetermined facility 800. In various cases, the charge source 110 may be implemented by a stationary charging unit 320 at the predetermined facility 800 or by a mobile charging unit 300 that can move within the predetermined facility 800.

In this embodiment, the charging command sub-process 820 may, in a manner similar to that which has already been stated, produce a charging command 1200, which may comprise information 700 regarding the electric vehicle 100 to be charged, similar to that discussed above in connection with FIG. 10.

The charging command 1200 can be output to be communicated to the valet 230 over a communications network 1310, such as to a communication device 380 associated with the valet 230. In order to communicate the charging command 1200 from the CSOC 150 to the valet 230, a variety of approaches could be used.

For example, in some embodiments, an SMS or email message conveying the charging command 1200 could be sent from the CSOC 150 to a phone number or email address associated with the valet 230. In other cases, the valet 230 may have a social networking account such that the charging command can be delivered via a user update effected by the underlying transmission mechanism of the social network (e.g., Facebook or Twitter, to name a few possibilities). In yet other cases, a phone call may be placed by the CSOC 150 to a phone number associated with a telephone of the valet 230 and leave an automated vocal message (e.g., a type of “robocall”) conveying the information about the electric vehicle 100 to be charged according to the charging command 1200. The communications network 1310 may be implemented by the Internet, the PSTN, and/or a cellular network, to name a few examples.

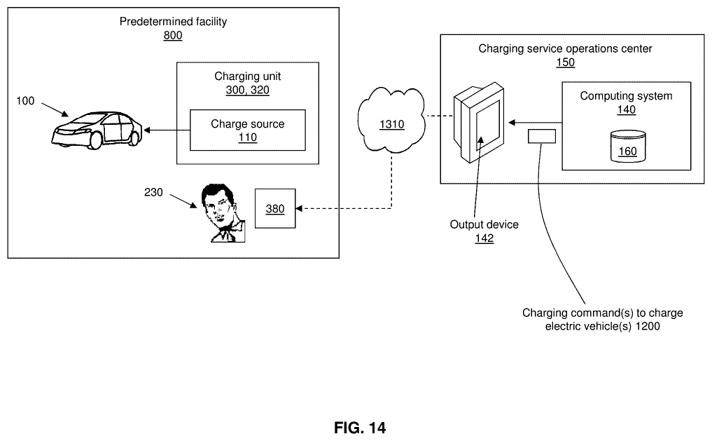

Alternatively, in some embodiments, with reference to FIG. 14, the information contained in the charging command 1200 could be output to a display, printer or other output device 142 (e.g., of a console, workstation, or other equipment) of the CSOC 150, where it can be perceived as a visual message by a customer service representative. The customer service representative may then respond by contacting the valet 230 (e.g., by phone, SMS or email) directly with the information about the electric vehicle 100 to be charged according to the charging command 1200 whose contents had been displayed, printed or otherwise output on the display, printer or other output device 142, such as the location, license plate, make, model, color, etc. of the electric vehicle 100 to be charged.

Upon receiving and interpreting the charging command 1200, or upon having been contacted by the customer service representative, the valet 230 can take actions to charge the electric vehicle 100 using the charge source 110 at the predetermined facility 800. In some cases, this may include retrieving the electric vehicle 100 from its current location (e.g., which may be remote from the predetermined facility 800) and moving it to another location that is within the predetermined facility 800 where it can be charged by the charge source 110. In some implementations, retrieving the electric vehicle 100 from its current location may involve driving the electric vehicle 100, whereas in other implementations, retrieving the electric vehicle 100 from its current location may involve transporting the electric vehicle 100 without driving it, such as by towing it with a tow truck or placing it on a flatbed truck.

It should be appreciated that, in some alternative embodiments, the charging command may include simply the identity of the electric vehicle 100 to be charged and then it is up to the valet 230 to determine the location of the electric vehicle 100. In that case, the valet 230 may be given access to GPS data for the identified electric vehicle 100 in order to locate it, may search for the vehicle 100 within the predetermined facility 800 if it is known or expected to be there (e.g., in a hotel parking lot), or may contact the user of the vehicle 100 to request location information.

As part of the charging command sub-process 820 in this embodiment, the CSOC 150 may consider a variety of factors when associating the electric vehicle 100 to be charged with a charging time. Examples of factors that may be taken into consideration include:
the location of the electric vehicle 100 needing to be charged;
the estimated time remaining before the electric vehicle 100 is to leave its current location;
the current battery charge level of the electric vehicle 100;

In order to allow the valet 230 to access and drive the electric vehicle 100, various approaches may be used. In one embodiment, a car key may be used by the valet 230 to start the electric vehicle 100. As such, the car key may be provided directly to the valet 230 by the user (e.g., owner or renter) of the electric vehicle 100. Alternatively, the car key may be left for the valet 230 in a lockbox and the valet 230 may be provided with a code for the lockbox. In other embodiments, the electric vehicle 100 is equipped with a reader for recognizing users and allowing only authorized users to enter the vehicle 100 and access a car key, which may be stored in a glove compartment of the vehicle 100.

The reader may be an RFID tag reader, a biometric reader, a magnetic card reader, etc., which can obtain information from the valet 230 from outside the vehicle 100 and process it before deciding whether access to the vehicle 100 should be allowed. Thus, the valet 230 may be suitably authorized in that the valet's RFID tag, biometrics or card code may be programmed in the reader. In still other embodiments, no physical car key is required, and full access to start and drive the electric vehicle 100 may be given as soon as the valet 230 is recognized as being an authorized user of the electric vehicle 100.

Of course, in some embodiments, a car key may not be required. A mere code (e.g., the code 760) may be sufficient to give the valet 230 control of the user's vehicle 100.

In some embodiments, the electric vehicle 100 to be charged may be parked by the user at an initial parking spot, and then may be brought by the valet 230 to a specific parking spot at the predetermined facility 800. The specific parking spot may be equipped with the charge source 110 for charging the electric vehicle 100 (e.g., a mobile charging unit 300 or a stationary charging unit 320). The vehicle 100 may then be returned to its initial parking spot where it may later be recovered by the user. Alternatively (e.g., if the initial parking spot is no longer available), the vehicle 100 may be driven by the valet 230 to a final parking spot, and the user may be advised (e.g., by text message or email or telephone call) as to the location of the user's vehicle 100 now that it has been charged. In still other embodiments, the user may specify the parking spot where he or she would like to have the vehicle 100 returned to once charging has been completed.

In other embodiments, the electric vehicle 100 to be charged need not be brought to a specific parking spot. Instead, the vehicle 100 may be left by the user or the valet 230 anywhere in the predetermined facility 800, and wires may be extended from the charge source 110 to the electric vehicle 100, thus avoiding having to drive the vehicle 100 for the purposes of charging it, and then potentially returning it. In this way, the user may be exposed to less uncertainty as to the whereabouts of his or her vehicle 100.

In each of the above implementations, after an electric vehicle has been charged, the CSOC 150 may receive an update for the purposes of updating the record 170 for the electric vehicle 100 in the vehicle account database 160. Specifically, the information that may updated may include the battery charge level information 180 and/or the vehicle location information 176 (in case the electric vehicle 100 has moved), to name a few possibilities.

It is to be understood that a second instance of the identification sub-process 810 may execute time before all the vehicles identified by the first instance of the identification sub-process 810 have actually been charged. Should this occur, the second instance of the identification sub-process 810 may produce a second list of electric vehicles that may include duplicates (i.e., some of the electric vehicles that have still not been charged further to the first instance of the identification sub-process 810). In terms of those duplicates (vehicles that continue to require charging), the urgency level may be increased (and/or the time left to charge may be reduced) since they were previously identified as requiring charging. The second list may also include additional electrical vehicles to be charged. The issuance of this second list can therefore trigger re-execution of the charging command sub-process 820, which may result in issuance of a potentially new charging schedule for the electric vehicles.

### F. Enhancement: Securing Access to Charge Port of Electric Vehicle

In some embodiments, the individual who charges an electric vehicle 100 from a mobile charging unit 300 or a stationary charging unit 320 may have unrestricted access to the charge port of the electric vehicle 100.

In other embodiments, access to the charge port of the electric vehicle 100 may be restricted. That is to say, the charge port may be inaccessible unless certain conditions are met.

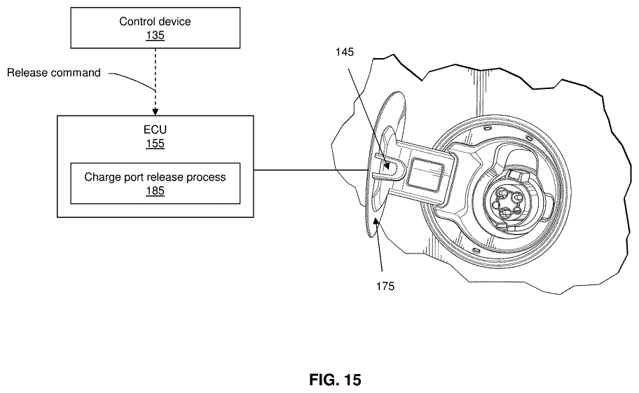

For example, with additional reference to FIG. 15, consider an embodiment where the electric vehicle 100 provides an electronically-controlled lock 145 (e.g., latch) that can retain a door, shutter or other cover 175 over the charge port to selectively lock and unlock the charge port. The lock 145 can be released or disengaged upon an electrical release signal provided by an ECU 155 of the electric vehicle 100. When released, the door, shutter or cover 175 is released, exposing the charge port. When charging is complete, the door, shutter or cover 175 is placed back into position, retained by the lock 145.

The release signal may be issued by the ECU 155 when a certain condition is met. Specifically, the ECU 155 may execute a charge port release process 185, which monitors parameters and determines whether the condition is met.

One example of a condition may include that a in-vehicle button has been pressed or an in-vehicle lever has been pulled.

Another example of a condition may include that a release command has been received from a control device 135 that is external to the electric vehicle 100. In some cases, it is envisaged that the release command may be supplied over a short-range wireless communication link from the control device 135 which is nearby and which may include, for example, a Bluetooth-enabled device, WI-FI-enabled device or RFID transceiver that may be operated by an individual who charges the electric vehicle 100. In other cases, it is envisaged that the release command may be supplied over a longer-range wireless communication link such as a 3G, 4G or other cellular connection or a Wi-Max channel, in which case the control device 135 may be near the electric vehicle 100 or at a remote site (e.g., part of the CSOC 150). In this way, the control device 135, which may include a smartphone, tablet or laptop or any other suitable equipment, could be used to free up access to the charge port, based on a short-range or network communication path.

It is contemplated that the release command may be encoded to facilitate error-free transmission over the channel over which it is transmitted. A code could also be used to enhance security. Security can be further enhanced through the use of encryption. For instance, encryption may be achieved using one or more cryptographic keys. In one embodiment, a symmetric (single-key) system is used, whereby the same key used for encryption is also used for decryption. In another embodiment, an asymmetric key pair is used, consisting of a private key and a public key. The private key may be used by authorized equipment to encrypt the release command prior to transmission. At the electric vehicle 100, the ECU 155 uses the corresponding public key to decrypt the release command. Thus, for example, a private/public key pair may be associated with the vehicle and the aforementioned control device 135. Of course, there may be multiple private/public key pairs that could be authorized for multiple entities.

In still other cases, the user of the electric vehicle 100 may further restrict access to the charge port by programming the ECU 155 to not accept charging under certain circumstances, such as at certain times of day or in certain geographic areas. For example, once the charge level is above, say, 90%, the ECU 155 may block all attempts to charge the electric vehicle 100 other than at the user's residence, unless overridden by the user. As long as this is not inconsistent with the charging rules that the user has specified to the CSOC 150, this may allow the user to rest assured that no unauthorized access to the charge port will occur, thereby preventing tampering and also double-billing.

### G. Enhancement: Estimate of Remaining Driving Range

In some embodiments, the user of an electric vehicle 100 may wish to specify, as one of the charging rules, that the electric vehicle be charged when an estimated remaining driving range (e.g., distance and/or time) is less than a particular threshold (e.g., less than 3 hours and/or 50 km). The threshold can be system-defined (e.g., by the CSOC 150) or user-defined, and it may be fixed or variable.

For example, in some embodiments, the identification sub-process 820 of the condition verification process 430 executed by the CSOC 150 may calculate the estimated remaining driving range for the electric vehicle 100. In order to calculate the estimated remaining driving range, a variety of parameters may be considered, each having their own impact on the battery drain of the electric vehicle 100. For instance, these parameters may include:
a route (e.g., a usual or expected route taken by the electric vehicle 100 or a user-defined route, where different routes have different lengths, speed limits, etc., each of which may impact battery drain);
terrain or road type (e.g., highway versus city, incline/grade, paved road versus gravel. For example, the battery will be drained significantly more when a steep incline is being climbed than when driving downhill);
traffic conditions (e.g., high traffic load will result in a longer time to travel the same distance, as well as more frequent acceleration and braking, which may have an impact on battery drain);
weather conditions (e.g., outside temperature, taking into account not only the extra drain on the electric vehicle's battery due to extreme heat or cold, but also the energy usage due to heating or air conditioning);
time of day (e.g., daytime versus nightime, taking into account lights usage, as a function of time of year and geographical location such as latitude/longitude)
drag coefficient and other properties of the electric vehicle 100;
etc.

It should be appreciated that the estimated remaining driving range can be useful in other scenarios where the charging service contemplated herein need not be provided. For example, a user of an electric vehicle 100 may generally wish to know how much estimated driving time or distance there is left if a certain route or route profile is taken or whether an estimated driving time or distance is sufficient to make it to a given destination.

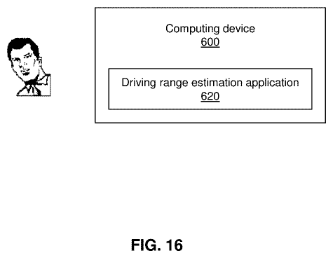

For example, in some embodiments, with additional reference to FIG. 16, a driving range estimation application 620 may be provided on a computing device 600 (e.g., a smartphone or a tablet or other computer) used by the user of the electric vehicle 100.

In one embodiment, the user may input (e.g., define or select) a route to be taken with the electric vehicle 100 into the driving range estimation application 620. In some cases, the driving range estimation application 620 may allow the user to specify the route directly in the application 620. To that end, the application 620 may include web mapping or route planning functionality such as that implemented by web mapping or route planning applications (e.g., Google Maps, MapQuest, etc). In other cases, the user may specify the route in another application, such as a web mapping or route planning application, running on or accessed by the computing device 600, and the driving range estimation application 620 may import or otherwise access information about the route from that other application. The driving range estimation application 620 obtains information about a current charge level of the battery of the electric vehicle 100. For instance, the driving range estimation application 620 may obtain the information about the battery's current charge level from an ECU of the electric vehicle 100 via a communication link between the computing device 600 and the ECU (e.g., a Bluetooth or other short-range wireless link or a wired link to a USB or other cable port of the electric vehicle). Alternatively, the user may input the battery's current charge level as visually observed from the electric vehicle's dashboard into the driving range estimation application 620. Other information regarding the weather, time of day, terrain, etc. can be obtained by the driving range estimation application 620 as discussed earlier, from the user and/or from other sources (e.g., an ECU of the electric vehicle, a GPS unit providing terrain and/or traffic conditions, a weather website, etc.). Based on the obtained information, the driving range estimation application 620 can calculate an estimated remaining driving range (e.g., distance and/or time) of the electric vehicle 100 if the route is actually taken.

In another embodiment, a destination can be entered by the user into the driving range estimation application 620 and, based on the calculation of the estimated remaining driving distance or time as described above, the application 620 can output an indication of the likelihood that the electric vehicle 100 can make it to its destination. This computation may also take into consideration the location of the nearest charge source 110 (e.g., a charging station dedicated to charging electric vehicles). In this way, not only is the location of the destination taken into consideration, but also the distance from the destination to the nearest charge source 110. The driving range estimation application 620 can thus tell the user the likelihood that the electric vehicle 100 will make it to the destination with enough charge left to make it to the closest charge source 110 thereafter.

### H. Enhancement: Recharging of Rental Vehicles

In some embodiments, it is envisaged that the user of an electric vehicle 100 requiring charging may be a renter of the electric vehicle 100, which is rented from a vehicle rental company (e.g., Hertz, Avis, Alamo, National, or any other car rental company). In such a scenario, the renter may not be familiar with the procedures involved in recharging the rental electric vehicle 100, nor may be familiar with the locations of publicly-available charging stations, or may not feel comfortable using them for various reasons such as personal safety and/or time constraints.

For these and/or other reasons, in some embodiments, the user may enter into a rental agreement with the vehicle rental company for renting the electric vehicle 100 in which a charging option is selectable by or provided by default to the user upon rental of the vehicle 100. With this charging option, the vehicle rental company assumes at least partial responsibility for causing the electric vehicle 100 to be recharged while it is being rented by the user. For example, this may be achieved by providing the charging service as described in embodiments discussed above.

Furthermore, recognizing that car rentals are frequently correlated with hotel stays, in some embodiments, it may be convenient to locate charging facilities at certain hotels. In particular, a hotel (e.g., which may be part of a hotel chain) and the vehicle rental company may have an agreement whereby the charging option provided to the renter of the electric vehicle 100 (by default or by being selected by the renter) would be activated if and when the renter stays at the hotel. The hotel may be advised of the renter's charging option. According to this agreement, the hotel assumes at least partial responsibility for recharging the electric vehicle 100 when surrendered to a parking facility associated with the hotel. As such, the rental agreement may be a three-party agreement that binds the renter of the electric vehicle 10, the vehicle rental company, and the hotel (or hotel chain, if applicable).

Thus, when arriving at the hotel, the renter of the electric vehicle 100 need simply check in and the renter's hotel reservation is linked with the charging option provided to the renter. Thus, effectively, the aforementioned clause of the rental agreement is activated. This would allow the renter to leave (e.g., surrender) the vehicle 100 in the parking garage, lot or other facility at a desired or designated spot. This spot need not be equipped with a charging station. Then, the renter of the vehicle 100 may provide the keys to a front desk attendant, receptionist or other hotel employee, who would then be in charge of having the vehicle 100 charged if and when necessary or requested. The vehicle 100 could thus be charged in accordance with the aforementioned clause of the rental agreement. This could take place during certain key periods of idleness, such as overnight or during a meeting/conference at the hotel. The vehicle 100 could be returned to its original parking spot or it could be parked elsewhere, and the renter of the vehicle 100 advised of the new spot. The electric vehicle 100 would then be retrieved by the renter from the parking facility, having been recharged in accordance with the aforementioned clause of the rental agreement.

Payment for charging could be integrated with the hotel invoice or with the vehicle rental invoice, or split between the two. Naturally, the hotel and/or the vehicle rental agency may subsidize part of the cost of charging the electric vehicles 100, in return for exclusive partnership, for example. As such, a “roaming” fee could be charged by hotel A that has a partnership with vehicle rental agency X, when it receives charging requests from renters of vehicles from vehicle rental agency Y.

Similar services could be provided to users of the hotel's facilities who may not be renters of electric vehicles but may simply register, with a front desk attendant or other employee of the hotel, their desire to have their electric vehicle charged. As such, it is envisaged that such an on-demand lot-based charging service could be offered in a parking lot or shopping center context, in addition to a hotel context.

### I. Variant: Recharging at Hotels and Other Paying Facilities

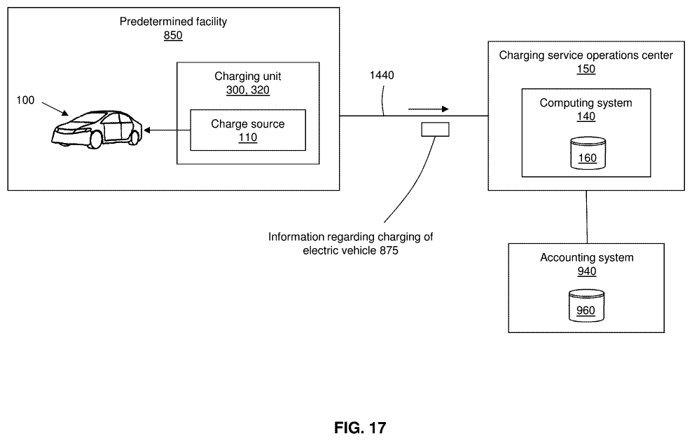

In some embodiments, with additional reference to FIG. 17, the user of an electric vehicle 100 may stay at, or otherwise bring the electric vehicle 100 to, a predetermined facility 850 which requires payment for the user's stay and/or parking of the electric vehicle 100 and at which the electric vehicle 100 can be charged using a charge source 110 at that predetermined facility 850. In various examples, the predetermined facility 850 may be a hotel, an office building, an airport, an arena or stadium, a hospital, a shopping center, a parking lot, or any other suitable public or private place which requires payment for users' stays and/or parking of vehicles at that place. The CSOC 150 monitors charging of electric vehicles using the charge source 110 at the predetermined facility 850. For example, this can be done to record or otherwise track charging events at the predetermined facility 850, such as to automatically add or otherwise apply a cost (e.g., a fee) for charging an electric vehicle to a price or other monetary amount owed for staying and/or parking at the predetermined facility 850.

For purposes of this example, it is assumed that the predetermined facility 850 is a hotel at which the user of the electric vehicle 100 stays and that the electric vehicle 100 is charged using the charge source 110 at the hotel 850 (e.g., in a parking lot of the hotel 850). In various embodiments, the charge source 110 may be implemented by a stationary charging unit 320 at the hotel 850 or by a mobile charging unit 300 that can move within the hotel 850. In some cases, the user may himself/herself charge the vehicle 100 using the charge source 110. In other cases, an employee of the hotel 850 may charge the vehicle 100 using the charge source 110, such as described previously in other embodiments.

The CSOC 150 receives information 875 regarding the electric vehicle 100 that is charged. The information 875 allows an association to be made between (i) the charging of the electric vehicle 100 and (ii) an account of the electric vehicle's user at the hotel 850. For example, the information 875 may allow an identification of the electric vehicle 100 itself and/or the user of the vehicle 100 himself/herself, and may indicate an amount of charge delivered to the electric vehicle 100. This may be achieved in any suitable way.

For example, in some embodiments, the individual (e.g., the electric vehicle's user or the hotel's employee) charging the electric vehicle 100 may provide information identifying the vehicle 100 and/or its user (e.g., the user's name and/or room number; the vehicle's make, model, registration number, etc.), such as by entering this information and/or presenting a hotel room card via a user interface of the charging unit 300, 320 that charges the vehicle 100. As another example, in other embodiments, information identifying the vehicle 100 and/or its user may be automatically captured by equipment of the hotel 850 (e.g., part of or near the charging unit 300, 320), such as a camera capturing images relevant to the charging of the electric vehicle 100 (e.g., a license plate or other image of the electric vehicle 100, and/or image of the vehicle's user) which can be processed to identify the account of the electric vehicle's user at the hotel 850. Also, in some embodiments, the amount of charge delivered to the electric vehicle 100 may be measured by the charging unit 300, 320 and conveyed as part of the information 875.

The information 875 regarding the electric vehicle 100 that is charged may be communicated to the CSOC 150 over a communication link 940, which may be implemented by a local-area network (LAN), the Internet, the PSTN, and/or a cellular network, to name a few examples.

Upon receiving the information 875, the CSOC 150 processes it to associate the charging of the electric vehicle 100 and to the account of the electric vehicle's user at the hotel 850. For instance, the identity of the electric vehicle 100 and/or of its user can be derived from the information 875 and correlated to the account of the vehicle's user (e.g., identified by the user's room number or other customer identifier) in a database 960 of an accounting system 940 of the hotel 850 that manages accounts of guests of the hotel 850.

A cost (e.g., a fee) may be applied to the account of the user of the electric vehicle 100 for charging of the electric vehicle 100. For example, in some cases, the cost may be related to the amount of charge delivered to the electric vehicle 100 and/or to other factors (e.g., a period, such as a day or time of day, during which the charging of the electric vehicle 100 occurred; whether the user of the vehicle 100 himself/herself or an employee of the hotel 850 charged the vehicle 100; etc.). In other cases, the cost may be fixed, such as a fixed fee for a charging event (e.g., $15), regardless of how much charge was actually delivered to the electric vehicle 100.

The account of the user of the electric vehicle 100 is thus adjusted based on the cost for charging the electric vehicle 100. Thus, the user of the electric vehicle 100 may be billed for the charging of the electric vehicle 100. This may ultimately be reflected in an invoice issued for the user's stay at the hotel 850.

### J. Variant: Online Booking Process

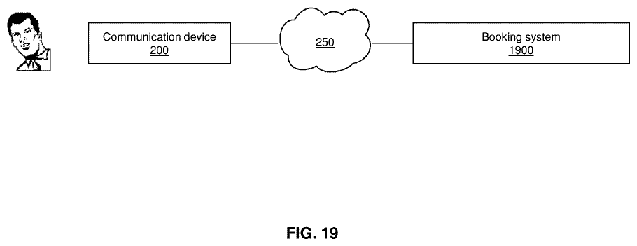

In some embodiments, with reference to FIG. 19, there may be a booking system 1900 to which the user may connect (using the communication device 200) over the network 250. For example, the booking system 1900 may be accessible through a website. The booking system 1900 may include a processor and a memory, wherein the processor executes computer-readable instructions stored in the memory for implementing a booking process. In one example, the booking process is a hotel reservation process. In another example, the booking process is an automobile or other vehicle reservation process. In other examples, the booking process may be an event ticket reservation process, while in still other examples, the booking process may be an airline park-n-fly reservation process, to name a few non-limiting possibilities.

In an example of implementation, the booking process may involve implementing a graphical user interface (GUI) on the communication device 200 through which the user may interact.

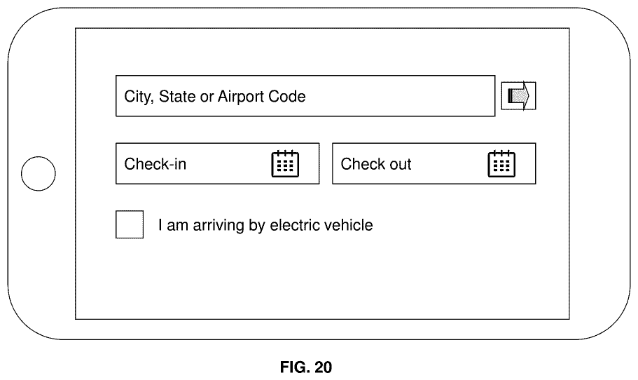

FIG. 20 shows an example GUI when the booking process is a hotel reservation process that may be presented on a screen of the communication device 200. In non-limiting embodiment, the hotel reservation process may be executed by a server of a hotel, a hotel chain or a travel agency/reservation hub. It will be seen that GUI objects are provided for allowing the user to enter information about a hotel reservation such as city, check-in date and check-out date. Other information may also be elicited from or selectable by the user, such as number of travellers (adults/children), name of hotel chain, price range, number of rooms, number/size of beds, category of room (e.g., number of stars, ocean view, garden view), smoking/non-smoking, high floor, etc.

In addition, one or more GUI objects in FIG. 20 may be provided for allowing the user to specify electric vehicle information in association with the reservation. In this specific case, the electric vehicle information includes information indicating whether the user intends to arrive with an electric vehicle. In the illustrated embodiment, this information is shown as being inputtable using a check box but of course other mechanisms are possible, such as a menu item, button, radio dial, etc.

When the user enters that the user intends to arrive with an electric vehicle, this may have multiple effects. Firstly, this may alleviate range anxiety on the part of the user, because it may give the user comfort that the hotel has specific provisions for charging electric vehicles, hence resulting in potentially increased sales for the hotel. Secondly, this may allow the hotel to prepare for the user's arrival by reserving charging resources (e.g., a charging station, a valet, parking space, etc.) for the user. It may also allow the hotel to provide a more accurate reflection of the anticipated cost of the user's stay because it may already incorporate a fee for electric vehicle charging into the estimated price.

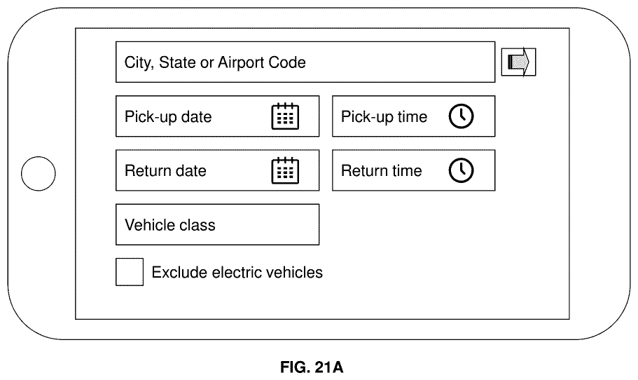

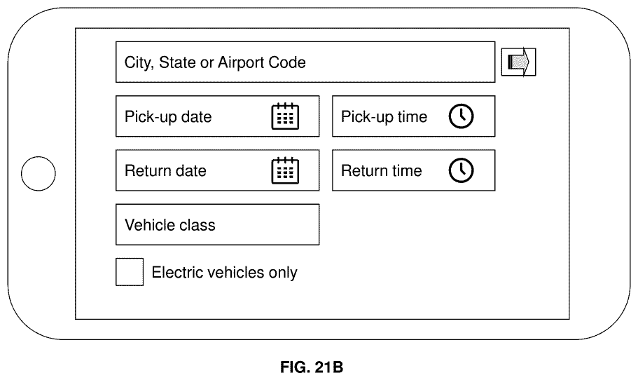

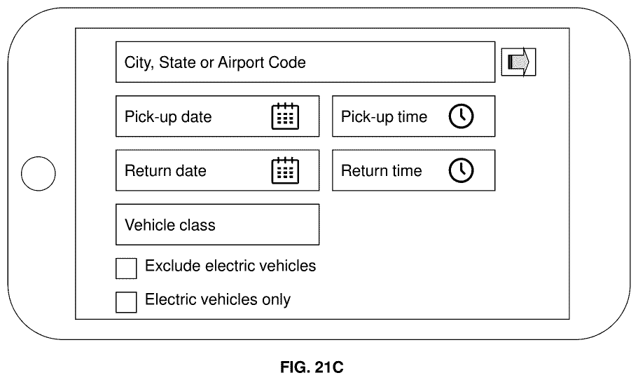

FIGS. 21A to 21C show example GUIs for an automobile reservation process when the booking process is an automobile reservation process that may be presented on a screen of the communication device 200. In non-limiting embodiment, the automobile reservation process may be executed by a server of a car rental company or a travel agency/reservation hub. It will be seen that GUI objects are provided for allowing the user to enter reservation criteria for an automobile rental, such as city, pickup date/time and return date/time. Stated differently, the GUI may present GUI objects via which the user is able to submit a request to view a set of automobiles available to be rented in accordance with reservation criteria. Other information may also be elicited from or selectable by the user, such as vehicle class (economy, mid-size, luxury, etc.), driver's age, driver's country of residence, coupon code, alternate return site, vehicle color, vehicle make, price range, mileage limit, etc. In addition, one or more GUI objects in FIG. 21A to 21C may be provided for allowing the user to input electrical vehicle information to restrict the set of automobiles from which a selection can be made, based on the electrical vehicle information.

In the specific case of FIG. 21A, the electric vehicle information includes information indicating that the user intends to exclude electric vehicles from the list of available automobiles. In the specific case of FIG. 21B, the electric vehicle information includes information indicating that the user intends to limit the list of available automobiles to only electric vehicles. In the specific case of FIG. 21C, the electric vehicle information includes information indicating that the user either intends to exclude electric vehicles from the list of available automobiles or limit the list of available automobiles to only electric vehicles, with the understanding that only one of these boxes can be checked. However, it is possible to not check any of these boxes, which would then result in a list of automobiles that may or may not include electric vehicles and non-electric vehicles, depending on which vehicles are available for the selected location and rental period (and other criteria).

In the illustrated embodiment, electric vehicle information is shown as being inputtable using a check box (two check boxes in FIG. 21C) but of course other mechanisms are possible, such as a menu item, button, radio dial, etc. Allowing the user to enter electric vehicle information as in FIG. 21A may also allow a user who has range anxiety to know, at the time of inputting reservation requirements, that he or she will not be presented with electric vehicles and therefore will not have to worry about the possibility of mistakenly renting an electric vehicle. Conversely, allowing the user to enter electric vehicle information as in FIG. 21B may allow a user who insists on renting an electric vehicle to ensure that the choices that he/she will be presented with are limited to electric vehicles, which may make the car rental process simpler and/or more convenient.

It should be appreciated that the booking system 1900 may optionally be connected to a hotel where the user has booked a room. In this implementation, the hotel manages the predetermined facility 850, such as a parking lot. When the user checks in to the hotel, the information about the user's reservation, including the fact that the user intended to arrive with an electric vehicle, may be confirmed with the user.

In a first non-limiting implementation, upon check-in, information about charging rules may be collected by a guest services representative and entered into the CSOC 150. The user may also supply charging rules using, for example, a hotel-run software application. From that point on, for the duration of the user's hotel stay, the electric vehicle may be charged by hotel staff according to the charging rules, in one of the various ways described above. The user may be billed each time the electric vehicle is charged or in accordance with a flat (e.g., daily) rate, to name two non-limiting possibilities.

In a second non-limiting implementation, charging on the hotel premises is effected by the user himself/herself, such as at designated charging stations within the parking facility 850. The user may be may be billed each time the electric vehicle is charged or in accordance with a flat (e.g., daily) rate, to name two non-limiting possibilities. When self-charging the electric vehicle, the user may need to identify himself/herself in order to link the charging activity with the account data that will be billed. For this purpose, the user may be asked to enter a code at the fixed or mobile charging station, or may be asked to swipe a hotel card or approach with a hotel-issued RFID badge, or present a two-dimensional bard code to a scanner associated with the charging station.

The aforementioned second non-limiting implementation may also take effect even in the absence of a booking system 1900. Specifically, it can be envisaged that embodiments of the present invention may apply in diverse scenarios where a charging activity at a facility may be linked with a user's account that has already been activated in association with a payable service other than electric vehicle charging. The amount that the user pays for the payable service may therefore be adjusted based on the charging of the electric vehicle. The facility could be a hotel, parking lot, stadium, etc.

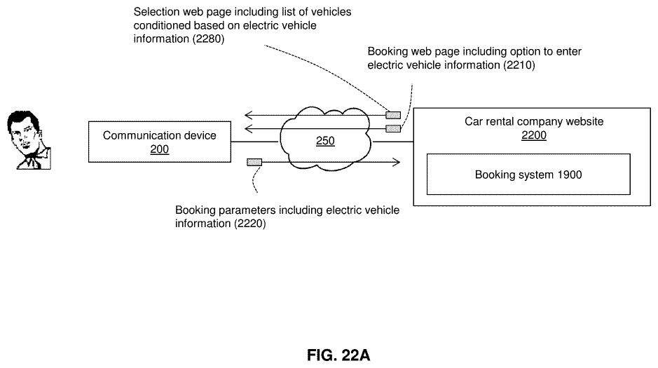

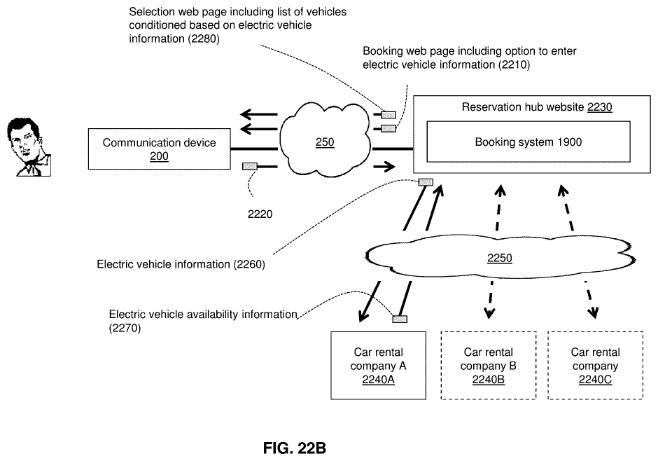

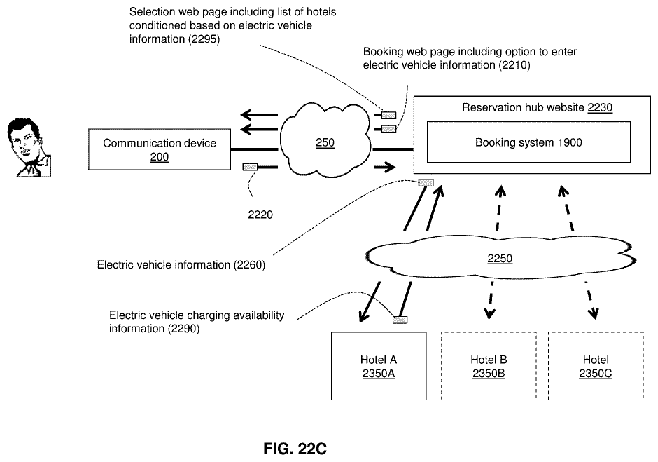

Reference is now made to FIG. 22A, in which the booking system 1900 is described in greater detail, in the specific non-limiting case where the booking system is implemented by a car rental company website 2200, such as offered by enterprise.com, hetz.com, avis.com, budget.com, etc. In this case, the user accesses the car rental company website 2200 over the network 250 using the communication device 200. The booking system may provide a booking web page 2210 that includes an option for the user to enter electric vehicle information. This may be in the form that was described in FIGS. 21A-21C, in a non-limiting scenario. The user interacts with this website and supplies, via the communication device 200, booking parameters 2220 that may include electric vehicle information. In two non-limiting examples, this could be information indicating the user's interest in limiting the set of available vehicles to those that are electric vehicles, or information indicating the user's interest in excluding from the list of available vehicles those that are electric. In response to receiving the booking parameters 2200, the booking system 1900 determines a suitable list of vehicles (or vehicle types) to present to the user, which are provided in the form of a selection web page 2800 from which the user may select a vehicle (or vehicle type). The content of the selection web page 2800 (including the list of available vehicles or vehicle types) may be conditioned based upon the booking parameters 2200, including for example rental location and the aforesaid electric vehicle information.

Reference is now made to FIG. 22A, in which the booking system 1900 is described in greater detail, in the specific non-limiting case where the booking system is implemented by a multi-modal reservation hub website 2300, such as offered by expedia.com, hotels.com, travelocity.com, etc. In this case, the user accesses the reservation hub website 2300 over the network 250 using the communication device 200. The booking system may provide a booking web page 2210 that includes an option for the user to enter electric vehicle information. This may be in the form that was described in FIGS. 21A-21C, in a non-limiting scenario. The user interacts with this website and supplies, via the communication device 200, booking parameters 2220 that may include electric vehicle information. In two non-limiting examples, this could be information indicating the user's interest in limiting the set of available vehicles to those that are electric vehicles, or information indicating the user's interest in excluding from the list of available vehicles those that are electric. In response to receiving the booking parameters 2200, the booking system 1900 contacts one or more car rental companies 2240A, 2240B, 2240C. Specifically, communication between the booking system 1900 and the car rental companies 2240A, 2240B, 2240C may occur over a data network 2250 such as the data network 250, which could be the Internet. When contacting a particular car rental company (e.g., car rental company 2240A), the booking system 1900 at the reservation hub website 2230 may send reservation criteria, including electric vehicle information 2260, over the network 2250. These reservation criteria include criteria specified by the user and therefore in a non-limiting embodiment, the may include the aforementioned electric vehicle information (e.g., information indicating the user's interest in limiting the set of available vehicles to those that are electric vehicles, or information indicating the user's interest in excluding from the list of available vehicles those that are electric). In response, a system at the car rental company 2240 returns availability information about vehicles that meet the reservation criteria, including the at least one electric vehicle information. This information may be obtained by consulting a database, for example. The availability information that is returned to the booking system 1900 may therefore include electric vehicle availability information 2270, which may comprise a set of vehicles that is constrained so as to meet the electric vehicle information (as one of the reservation criteria). The booking system 1900 compiles the vehicle availability information, including electric vehicle availability information 2700, received from one or more car rental companies and presents it to the user, e.g., in the form of a selection web page 2800 from which the user may select a vehicle (or vehicle type). The content of the selection web page 2800 (including the list of available vehicles or vehicle types) will thus be conditioned based upon the booking parameters 2200, including for example rental location and the aforesaid electric vehicle information.

In the case of hotel reservations, as shown in FIG. 22C, a similar communication set may be established between the reservation hub 2230 and individual hotels (e.g., which may be part of different hotel chains), rather than car rental companies. In this case, the electrical vehicle information provided by the user in the booking parameters 2220 may indicate the user's interest in limiting the set of available hotels to those that provide for charging of the electric vehicles (e.g., have available charging units and/or offer a charging service). In response to receiving the booking parameters 2200, the booking system 1900 contacts one or more hotels 2350A, 2350B, 2230C. Specifically, communication between the booking system 1900 and the hotels 2350A, 2350B, 2350C may occur over the data network 2250 such as the data network 250, which could be the Internet. When contacting a particular hotel (e.g., hotel 2350A), the booking system 1900 at the reservation hub website 2230 may send reservation criteria, including electric vehicle information 2260, over the network 2250. These reservation criteria include criteria specified by the user and therefore in a non-limiting embodiment, this may include the aforementioned electric vehicle information (e.g., information indicating the user's interest in limiting the set of available hotels to those that provide for charging of electric vehicles). In response, a system at the hotel 2350 returns availability information to the booking system 1900 that may therefore include electric vehicle charging availability information 2290, which may indicate that the hotel provides or does not provide for charging of electric vehicles. The booking system 1900 compiles the hotel availability information, including electric vehicle charging availability information 2290, received from one or more hotels and presents it to the user, e.g., in the form of a selection web page 2295 from which the user may select a hotel. The content of the selection web page 2295 (including the list of available hotels) will thus be conditioned based upon the booking parameters 2200, including for example the hotel location and the aforesaid electric vehicle information.

In some cases, both car rental and hotel reservations may be effected based on only a single entry of an electric vehicle criterion (e.g., preference for or against electric vehicles) at the outset of the booking process.

In various embodiments, a communications network mentioned herein (e.g., the communications network 250, the communications network 910, the communications network 1110, the communications network 1310, the communications network 2250, etc.) may be implemented by a data network (e.g., the Internet), a public telephony network (e.g., the PSTN), and/or a wireless network (e.g., a cellular network, a satellite network link). Also, in some cases, while two or more communications networks may be referred to, identified or shown separately, they may be implemented by a common network infrastructure.

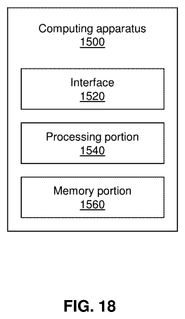

In some embodiments, as shown in FIG. 18, a given component mentioned herein (e.g., the computing system 140 of the CSOC 150, the communication device 200 of a user, the control device 135 for accessing the charge port of an electric vehicle 100, the computing device 600 of a user, the accounting system 940, the booking system 1900, the websites 2200, 2300, etc.) may comprise a computing apparatus 1500 comprising suitable hardware and/or software (e.g., firmware) configured to implement functionality of that given component. The computing apparatus 1500 comprises an interface 1520, a processing portion 1540, and a memory portion 1560.

The interface 1520 comprises one or more inputs and outputs allowing the computing apparatus 1500 to receive signals from and send signals to other components to which the computing apparatus 1500 is connected (i.e., directly or indirectly connected);

The processing portion 1540 comprises one or more processors for performing processing operations that implement functionality of the computing apparatus 1500. A processor of the processing portion 1540 may be a general-purpose processor executing program code stored in the memory portion 1560. Alternatively, a processor of the processing portion 1540 may be a specific-purpose processor comprising one or more preprogrammed hardware or firmware elements (e.g., application-specific integrated circuits (ASICs), electrically erasable programmable read-only memories (EEPROMs), etc.) or other related elements;

The memory portion 1560 comprises one or more memories for storing program code executed by the processing portion 1540 and/or data used during operation of the processing portion 1540. A memory of the memory portion 1560 may be a semiconductor medium (including, e.g., a solid state memory), a magnetic storage medium, an optical storage medium, and/or any other suitable type of memory. A memory of the memory portion 1560 may be read-only memory (ROM) and/or random-access memory (RAM), for example.

In some embodiments, two or more elements of the computing apparatus 1500 may be implemented by devices that are physically distinct from one another (e.g., located in a common site or in remote sites) and may be connected to one another via a bus (e.g., one or more electrical conductors or any other suitable bus) or via a communication link which may be wired, wireless, or both and which may traverse one or more networks (e.g., the Internet or any other computer network such as a local-area network (LAN) or wide-area network (WAN), a cellular network, etc.). In other embodiments, two or more elements of the computing apparatus of the vehicle 10 may be implemented by a single device.

Any feature of any embodiment discussed herein may be combined with any feature of any other embodiment discussed herein in some examples of implementation.

Certain additional elements that may be needed for operation of certain embodiments have not been described or illustrated as they are assumed to be within the purview of those of ordinary skill in the art. Moreover, certain embodiments may be free of, may lack and/or may function without one or more elements that are not specifically disclosed herein.

Although various embodiments and examples have been presented, this was for the purpose of describing, but not limiting, the invention. Various modifications and enhancements will become apparent to those of ordinary skill in the art and are within the scope of the invention.

1.-20. (canceled)

21. A computing apparatus for charging electric vehicles (EVs), the computing apparatus comprising a memory and a processor and being configured to perform:
a front end process for maintaining accounts of users of the EVs and interacting with the users to determine user-specified charging rules for the EVs; and
a condition verification process for monitoring charge levels of batteries of the EVs and dispatching mobile charging units to charge the batteries of the EVs according to the user-specified charging rules for the EVs.

22. The computing apparatus of claim 21, wherein the user-specified charging rules for the EVs define a time when the user of a given one of the EVs desires the given one of the EVs to be charged.

23. The computing apparatus of claim 22, wherein the time is defined by at least one of a day and a time of day.

24. The computing apparatus of claim 21, wherein the user-specified charging rules for the EVs define a plurality of times when the user of a given one of the EVs desires the given one of the EVs to be charged.

25. The computing apparatus of claim 21, wherein the user-specified charging rules for the EVs define the charge level of the battery of a given one of the EVs at which the user of the given one of the EVs desires the given one of the EVs to be charged.

26. The computing apparatus of claim 25, wherein the user-specified charging rules for the EVs define a time when the user of the given one of the EVs desires the given one of the EVs to be charged.

27. The computing apparatus of claim 21, wherein the user-specified charging rules for the EVs define a site where the user of a given one of the EVs desires the given one of the EVs to be charged.

28. The computing apparatus of claim 27, wherein the user-specified charging rules for the EVs define a time when the user of the given one of the EVs desires the given one of the EVs to be charged.

29. The computing apparatus of claim 21, wherein the dispatching comprises determining locations of the EVs based on signals from the EVs.

30. The computing apparatus of claim 21, wherein the dispatching comprises conveying commands to charge the EVs to operators of the mobile charging units.

31. A computing apparatus for charging electric vehicles (EVs), the computing apparatus comprising a memory and a processor and being configured to:
receive data defining conditions to charge the EVs from communication devices of users of the EVs;
determine that the conditions to charge particular ones of the EVs are met; and
output commands for at least one mobile charging unit to travel to locations of the particular ones of the EVs and charge the particular ones of the EVs at the locations of the particular ones of the EVs while the conditions to charge the particular ones of the EVs are met.

32. The computing apparatus of claim 31, wherein the conditions to charge the EVs include a time when the user of a given one of the EVs desires the given one of the EVs to be charged.

33. The computing apparatus of claim 32, wherein the time is defined by at least one of a day and a time of day.

34. The computing apparatus of claim 31, wherein the conditions to charge the EVs include a plurality of times when the user of a given one of the EVs desires the given one of the EVs to be charged.

35. The computing apparatus of claim 31, wherein: the computing apparatus is configured to monitor battery charge levels of the EVs; and the conditions to charge the EVs include the battery charge level of a given one of the EVs at which the user of the given one of the EVs desires the given one of the EVs to be charged.

36. The computing apparatus of claim 31, wherein the conditions to charge the EVs include a site where the user of a given one of the EVs desires the given one of the EVs to be charged.

37. The computing apparatus of claim 31, wherein the computing apparatus is configured to determine the locations of the EVs based on signals from the EVs.

38. The computing apparatus of claim 31, wherein, to output the commands, the computing apparatus is configured to convey the commands to at least one operator of the at least one mobile charging unit.

39. The computing apparatus of claim 31, wherein: the at least one mobile charging unit is a plurality of mobile charging units; and, to output the commands, the computing apparatus is configured to convey the commands to respective ones of the mobile charging units to travel to the locations of respective subsets of the particular ones of the EVs and charge the respective subsets of the particular ones of the EVs at the locations of the respective subsets of the particular ones of the EVs while the conditions to charge the particular ones of the EVs are met.

40. A system for charging electric vehicles (EVs), the system comprising:
portable charging units configured to charge batteries of the EVs; and
a computing apparatus configured to:
monitor charge levels of the batteries of the EVs;
determine locations of the EVs; and
output commands to deposit the portable charging units in proximity to the EVs for charging the EVs with the portable charging units, based on the locations of the EVs and the charge levels of the batteries of the EVs.
